(19) United States
(12) Patent Application Publication
(10) Pub. No.: US 2026/0014548 A1
(43) Pub. Date: Jan. 15, 2026

(54) Method for Manufacturing Porous Ionic Polymers for Water Remediation

(71) Applicants: Zhe Qiang, Hattiesburg, MS (US); Anthony Griffin, Hattiesburg, MS (US)

(72) Inventors: Zhe Qiang, Hattiesburg, MS (US); Anthony Griffin, Hattiesburg, MS (US)

(73) Assignee: The University of Southern Mississippi, Hattiesburg, MS (US)

(21) Appl. No.: 19/263,636

(22) Filed: Jul. 9, 2025

Related U.S. Application Data
(60) Provisional application No. 63/669,131, filed on Jul. 9, 2024.

(51) Int. Cl. B01J 20/26; B01J 20/28; B01J 20/30; C02F 1/28; C02F 101/30; C08F 8/36; C08J 3/24

(52) U.S. Cl. CPC B01J 20/267; B01J 20/28061; B01J 20/28071; B01J 20/28073; B01J 20/3085; C02F 1/285; C08F 8/36; C08J 3/247; C02F 2101/308; C08F 2810/20; C08J 2353/00

(57) ABSTRACT

A porous ionic polymer formed via a one-step reaction comprising a step of: crosslinking one or more thermoplastic elastomers in a presence of one or more acids comprising sulfur, and one or more free radical generators to form the porous ionic polymer. The method of forming the porous ionic polymer is also included. 3D structures can be formed by the porous ionic polymer. The porous ionic polymers are useful in applications requiring macro- and/or mesopores such as water remediation.

### CROSS REFERENCE TO RELATED APPLICATIONS

This application claims the benefit of U.S. provisional application No. 63/669,131, filed on Jul. 9, 2024, the disclosure of which is hereby incorporated by reference in its entirety as if fully set forth herein.

### STATEMENT OF GOVERNMENT INTEREST

This invention was made with government support under grant no. CMMI-2239408 awarded by the National Science Foundation. The Government has certain rights in the invention.

### TECHNICAL FIELD

The present invention relates to the field of polymer synthesis, and more particularly to a method of forming porous ionic polymers via a one-step reaction involving crosslinking thermoplastic elastomers in the presence of acids comprising sulfur and free radical generators as well as use of these porous ionic polymers in water remediation.

### BACKGROUND OF THE INVENTION

With global drinking water supply projected to decrease significantly in the coming decades as well as consistent contamination of water bodies by a wide range of pollutants, including heavy metal ions, organic pollutants, microplastics, and per- and polyfluorinated substances, there is a growing demand for efficient sorbents for water remediation. Conventional approaches have utilized ion exchange resins, membrane separation, and microporous carbon. The ion exchange strategy has been demonstrated as a potential route for the capture of many pollutants associated with existing manufacturing infrastructure from the last century. Ion exchange resins have been utilized for decades as sorbents for a variety of contaminants, including heavy metals and organic pollutants. However, there remains room for improved sorbent performance as well as simplified fabrication strategies. Further, the performance of ion exchange resins is still far from satisfactory, particularly due to their slow sorption kinetics and low sorption capacity. Additionally, most synthetic methods result in sorbents in powder or bead form. However, control over three-dimensional structure could enable improved performance and broader range of applications for the polymers.

U.S. 2023/0024512 relates to a carbon material formed using a polymer-based template structure. The carbon material is formed from a sulfonated crosslinked polyolefin having the chemical structure:

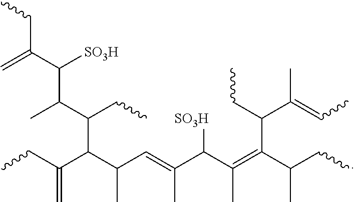

US 2023/0191364 relates to a method for manufacturing carbonized materials comprising sulfonating a carbonized material, such as carbonized polystyrene-block-poly(ethylene-ran-butylene)-block-polystyrene materials to form an ordered mesoporous structure.

### SUMMARY OF THE INVENTION

The present invention relates to a facile, one-step process to convert commercial, low-cost precursors to ion exchange sorbents with ordered mesoporous morphologies. This method can readily incorporate post-industrial waste as starting materials as well as utilize 3D-printed precursors to fabricate three-dimensional sorbents. The process employs a crosslinking reaction which imparts ionic character to the sorbent while simultaneously introducing mesopores. This reaction allows for scaled production of highly efficient sorbent materials. The crosslinked sorbents demonstrate rapid sorption of heavy metals and organic pollutants in aqueous environments, with ˜50 times higher sorption capacity and ˜10 times faster sorption kinetics compared to commercial ion exchange resin counterparts. The excellent sorbent performance coupled with the simple manufacturing process provides a material system applicable for various types of water remediation at a reasonable cost.

Mesoporous materials are porous materials with pore diameters in the range of 2-50 nm. These materials have unique features such as large pore volume, large specific surface areas, adjustable mesoporous channels, and easy surface modification.

The present invention may be described by the following sentences:

1. In a first aspect, the present invention relates to a method of forming a porous ionic polymer via a one-step reaction comprising a step of:
crosslinking one or more thermoplastic elastomers, for example, one or more copolymers comprising two or more blocks, or three or more blocks in the presence of one or more acids comprising sulfur, and one or more free radical generators to form the porous ionic polymer.

2. The method of sentence 1, wherein the crosslinking step is carried out at a temperature of from about 100° C. to about 200° C., or from about 125° C. to about 175° C., or about 150° C.

3. The method of any one of sentences 1-2, wherein the crosslinking step is carried out for a duration of from about 45 minutes to about 300 minutes, or from about 60 minutes to about 250 minutes, or from about 120 minutes to about 200 minutes, or about 150 minutes.

4. The method of any one of sentences 1-3, wherein the one or more free radical generators is selected from the group consisting of dicumyl peroxide, benzoyl peroxide, azosiobutyronitrile, 2,2′-azobis(2-methylpropionitrile), potassium persulfate, lauroyl peroxide, cumene hydroperoxide, tert-butyl hydroperoxide, azobisisobutyronitrile, di-tert-butyl peroxide, methyl ethyl ketone peroxide, cumyl hydroperoxide, peroxyacetic acid, and hydrogen peroxide.

5. The method of any one of sentences 1-4, wherein the one or more free radical generators is present in an amount of from about 0.001 wt. % to about 10 wt. %, or from about 0.05 wt. % to about 5 wt. %, or from about 0.01 wt. % to about 3 wt. %, based on a total weight of the combination of the one or more thermoplastic elastomers, the one or more acids comprising sulfur, and the one or more free radical generators.

6. The method of any one of sentences 1-5, wherein the one or more thermoplastic elastomers comprise a triblock polymer, wherein a first block, a second block, and a third block may each be independently selected from the group consisting of poly(styrene), poly(methacrylate), poly(methyl methacrylate), poly(ethylene), poly(butylene), and combinations thereof.

7. The method of any one of sentences 1-6, wherein the one or more thermoplastic elastomers is a poly(styrene)-block-poly(ethylene-ran-butylene)-block-poly(styrene) copolymer.

8. The method of any one of sentences 1-7, wherein the one or more thermoplastic elastomers is pristine, or incorporates post-industrial waste.

9. The method of any one of sentences 1-8, wherein the one or more acids is selected from the group consisting of sulfuric acid, sulfurous acid, thiosulfuric acid, peroxydisulfuric acid, polythionic acids, thiosulfurous acid, peroxymonosulfuric acid, dithionous acid, tetrathionic acid, and dithionic acid, preferably, the one or more acids is sulfuric acid.

10. The method of any one of sentences 1-9, wherein the one step reaction is configured to provide a porous ionic polymer with block copolymers, wherein each block comprises repeat units, wherein 1-20% of the repeat units are functionalized with sulfonic acid groups, or about 3-13% of the repeat units are functionalized with sulfonic acid groups, or about 5-10% of the repeat units are functionalized with sulfonic acid groups.

11. The method of any one of sentences 1-10, wherein the one or more mesoporous polymers has a pore volume of from about 0.1 cm³/g to about 0.7 cm³/g, as measured by nitrogen physisorption with Barrett-Joyner-Halenda analysis.

12. The method of any one of sentences 1-11, wherein the porous ionic polymer has a surface area of from about 50 m²/g to about 400 m²/g.

13. The method of any one of sentences 1-12, wherein the porous ionic polymer has an average pore diameter of from about 2 to about 50 nm, as measured by nitrogen adsorption isotherms.

14. The method of any one of sentences 1-13, wherein the porous ionic polymer is an ordered mesoporous polymer.

15. The method of claim 14, wherein the mesoporous polymer comprises self-assembled nanostructures, wherein the nanostructures are optionally selected from the group consisting of spheres, cylinders, and gyroids.

16. The method of any one of sentences 1-15, wherein the method excludes a calcination step after the crosslinking step.

17. In a second aspect, the present invention relates to a porous ionic polymer made by the method of any one of sentences 1-16.

18. The porous ionic polymer of sentence 17, wherein the one or more thermoplastic elastomers is in the form of a material selected from the group consisting of a powder, bead form, or additive manufactured product.

18. In a third aspect, the present invention relates to a water remediation device comprising the porous ionic polymer as made by the method of any one of sentences 1-17.

19. The water remediation device of sentence 18, wherein the water remediation device incorporates a 3D-printed precursor.

20. The water remediation device of any one of sentences 18-19, wherein the water remediation device is formed using additive manufacturing.

21. The water remediation device of any one of sentences 18-20, having an adsorption capacity for methylene blue of from about 50 mg/g to about 1000 mg/g of the porous ionic polymer, wherein the methylene blue has various initial dye concentrations (50 mg/L-800 mg/L).

### BRIEF DESCRIPTION OF THE DRAWINGS

The patent or application file contains at least one drawing executed in color. Copies of this patent or patent application publication with color drawing(s) will be provided by the Office upon request and payment of the required fee.

FIG. 1 shows solid-state carbon nuclear magnetic resonance (NMR) of an ordered mesoporous polymer (OMP) of the present invention prepared by sulfonation of poly(styrene)-block-poly(ethylene-ran-butylene)-block-poly(styrene) (SEBS) in the presence of dicumyl peroxide (DCP).

FIG. 2 shows Fourier transform infrared (FTIR) spectra of the OMPs as a function of reaction time.

FIG. 3 shows thermogravimetric analysis (TGA) thermograms up to 800° C. under air for various reaction times.

FIG. 4A shows pore size distributions determined from nitrogen adsorption isotherms for OMPs made using various different reaction times.

FIG. 4B shows pore volumes and surface areas of the OMPs as a function of reaction time.

FIG. 4C shows a Scanning Electron Microscope (SEM) micrograph of the mesoporous morphology of the OMP after 75 minutes of reaction time.

FIG. 4D shows the small-angle x-ray scattering (SAXS) profile of the OMP after 75 minutes of reaction time.

FIG. 5A shows the SAXS profile of a 3D-structured OMP.

FIG. 5B shows pore size distributions determined from nitrogen adsorption isotherms of the 3D-structured OMP.

FIG. 5C shows a SEM micrograph of the 3D-structured OMP.

FIG. 6A shows dye adsorption as a function of contact time for OMP sorption of methylene blue, a model pollutant, at a concentration of 100 mg/mL in water.

FIG. 6B shows dye adsorption isotherms between 50 mg/ml and 400 mg/mL for the OMP of the invention and a control polymer.

FIG. 7 shows a schematic illustration demonstrating the formation of OMP from thermoplastic elastomers (TPEs) through the copresence of sulfuric acid and radical species.

FIG. 8A shows FTIR spectra as a function of reaction time for neat SEBS.

FIG. 8B shows FTIR spectra as a function of reaction time for SEBS blended with 1 wt. % DCP (based on the weight of the SEBS).

FIG. 8C shows the degree of sulfonation, determined from titration experiments, and sulfur content, determined from XPS survey scans, as a function of reaction time for neat SEBS.

FIG. 8D shows the degree of sulfonation, determined from titration experiments, and sulfur content, determined from XPS survey scans, as a function of reaction time for SEBS blended with 1 wt. % DCP.

FIG. 9 shows ¹H NMR spectra of SEBS blended with 1 wt. % DCP and a PS control after 90 min of sulfonation.

FIG. 10A shows gel fraction as a function of reaction time for neat SEBS and SEBS blended with 1 wt. % DCP.

FIG. 10B shows TGA thermogram up to 800° C. under nitrogen for neat SEBS as control and reacted for various reaction times.

FIG. 10C shows TGA thermogram up to 800° C. under nitrogen for SEBS blended with 1 wt. % DCP reacted for various reaction times.

FIG. 11A shows TGA and DTG thermograms of neat SEBS after 30 min of reaction.

FIG. 11B shows TGA and DTG thermograms of SEBS blended with 1 wt. % DCP after 30 min of reaction.

FIG. 12A shows TGA and DTG thermograms of neat SEBS after 30 min of reaction.

FIG. 12B shows TGA and DTG thermograms of SEBS blended with 1 wt. % DCP after 30 min of reaction.

FIG. 13A shows SAXS profiles of polymers made using various reaction times.

FIG. 13B shows pore size distributions after reaction for various reaction times.

FIG. 13C shows pore textures of SEBS blended with 1 wt. % DCP after reaction for various reaction times.

FIG. 13D shows a SEM micrograph of OMP prepared using a 75 minute reaction time.

FIG. 14A shows a nitrogen physisorption isotherm of the OMP prepared using a 75 minute reaction time.

FIG. 14B shows pore size distribution for SEBS reacted for 2 hours with 0.07 wt. % DCP directly added to the reaction flask.

FIG. 15A shows a nitrogen physisorption isotherm of the SEBS reacted for 2 hours with 0.07 wt. % DCP directly added to the reaction flask.

FIG. 15B shows the pore size distribution of SEBS after 2 hours of reaction time at 150° C. in concentrated sulfuric acid with 0.07 wt. % azobisisobutyronitrile (AIBN).

FIG. 16A shows nitrogen physisorption isotherm after 2 hours of reaction time at 150° C. in concentrated sulfuric acid with 0.07 wt. % DCP.

FIG. 16B shows pore size distribution of an acrylonitrile butadiene styrene (ABS) copolymer (chemical structure shown in the inset of FIG. 16A) after 2 hours of reaction time at 150° C. in concentrated sulfuric acid with 0.07 wt. % DCP.

FIG. 17A shows images of SEBS blended with various dyes and additives.

FIG. 17B shows nitrogen physisorption isotherms of SEBS after 2 hours of reaction time with 0.07 wt. % DCP added to the reaction flask.

FIG. 17C shows pore size distributions of contaminated SEBS after 2 hours of reaction time with 0.07 wt. % DCP added to the reaction flask.

FIG. 18A shows dye adsorption as a function of contact time at a dye concentration of 100 mg/L for OMP and a commercial ion exchange sorbent.

FIG. 18B shows adsorption isotherms between 50 mg/L-800 mg/L fit for OMP and a commercial ion exchange sorbent.

FIG. 19A shows UV-vis adsorption spectra of crystal violet after adsorption with OMP and a commercial ion exchange sorbent (Cₒ=50 mg/L, t=48 hours, T=25° C.).

FIG. 19B shows UV-vis adsorption spectra of rhodamine B after adsorption with OMP and a commercial ion exchange sorbent (Cₒ=50 mg/L, t=48 hours, T=25° C.).

FIG. 19C shows UV-vis adsorption spectra of acid orange after adsorption with OMP and a commercial ion exchange sorbent (Cₒ=50 mg/L, t=48 hours, T=25° C.).

FIG. 20A shows SAXS profile of the 3D-structured OMP prepared from a 65:35 wt. % SEBS:PP blend reacted for 3 hours with an inset showing the 3D-structure.

FIG. 20B shows nitrogen physisorption isotherm of the 3D-structured OMP prepared from a 65:35 wt. % SEBS:PP blend reacted for 3 hours.

FIG. 20C shows pore size distribution of the 3D-structured OMP prepared from a 65:35 wt. % SEBS:PP blend reacted for 3 hours.

FIG. 20D shows a SEM micrograph of the 3D-structured OMP prepared from a 65:35 wt. % SEBS:PP blend reacted for 3 hours.

FIG. 21 shows pore size distribution of 3D-structured polymer prepared from a 65:35 wt. % SEBS:PP blend reacted for 1 hour, 2 hours, and 3 hours in sulfuric acid with presence of DCP.

FIG. 22 shows images of complex OMP 3D-structures.

FIG. 23A shows an atomic force microscopy (AFM) phase image of the neat SEBS film.

FIG. 23B shows an AFM phase image of the SEBS-SIS blend with 1 wt. % SIS (poly(styrene-block-poly(isoprene)-block-poly(styrene)).

FIG. 23C shows an AFM phase image of a SEBS-SIS blend with 5 wt. % SIS.

FIG. 23D shows an AFM phase image of a SEBS-SIS blend with 10 wt. % SIS.

FIG. 23E shows the chemical structures of SEBS and SIS with a schematic demonstrating macrophase separation behavior as a function of SIS concentration.

FIG. 24A shows FTIR spectra as a function of sulfonation time for bulk SEBS.

FIG. 24B shows FTIR spectra as a function of sulfonation time for SEBS-SIS blends with 1 wt. % SIS.

FIG. 24C shows FTIR spectra as a function of sulfonation time for the SEBS-SIS blends with 5 wt. % SIS.

FIG. 24D shows FTIR spectra as a function of sulfonation time for the SEBS-SIS blends with 10 wt. % SIS.

FIG. 25A shows SAXS profiles for bulk SEBS and SEBS-SIS films as cast.

FIG. 25B shows SAXS profiles for bulk SEBS and SEBS-SIS films after 1 hour of sulfonation.

FIG. 25C shows SAXS profiles for bulk SEBS and SEBS-SIS films after 2 hours of sulfonation.

FIG. 26A shows liquid nitrogen adsorption isotherms for bulk SEBS and SEBS-SIS blends sulfonated for 2 hours, where a type IV isotherm was observed for TPE blend precursors.

FIG. 26B shows associated pore size distributions of the materials of FIG. 26A. For clarity, isotherms were shifted in the Y-direction.

FIG. 26C shows pore volumes and surface areas as a function of SIS content.

FIG. 27A shows pore volume as a function of sulfonation time for bulk SEBS and SEBS-SIS blends.

FIG. 27B shows a schematic illustration of the sulfonation-induced crosslinking reaction resulting in formation of both macropores and mesopores.

FIG. 28A shows the pore size distribution with an inset of the corresponding nitrogen adsorption isotherm of SEBS sulfonated at 145° C. for 1 hour with 5 wt. % PPMA.

FIG. 28B shows the pore size distribution with an inset of the corresponding nitrogen adsorption isotherm of SEBS sulfonated at 145° C. for 2 hours with 5 wt. % PPMA.

FIG. 28C shows SEM micrographs displaying macroporous regimes of SEBS sulfonated at 145° C. for 2 hours with 5 wt. % PMMA.

FIG. 28D shows SEM micrographs displaying mesoporous regimes of SEBS sulfonated at 145° C. for 2 hours with 5 wt. % PMMA.

FIG. 29 shows SEM micrographs of bulk SEBS and SEBS-SIS blends sulfonated for 2 hours indicating dual macroporous and mesoporous regimes, with inset images confirming the presence of macropores (inset heights: 5.9 μm, inset lengths: 8.9 μm).

FIG. 30A shows CO²⁺ adsorption as a function of contact time at an initial metal ion concentration of 12 mg/L.

FIG. 30B shows Ni²⁺ adsorption as a function of contact time at an initial metal ion concentration of 12 mg/L.

FIG. 30C shows Co²⁺ and Ni²⁺ adsorption isotherms fit with a Langmuir isotherm model for HMM polymers.

### DETAILED DESCRIPTION OF THE INVENTION

In a first aspect, the present invention relates to a one-step method to directly convert commodity thermoplastic elastomers to ionic mesoporous crosslinked polymer sorbents, which exhibit exceptional water remediation performance. The addition of a small amount of a free-radical generator in the acid used for sulfonation during crosslinking reaction, causes polymer minority domains (non-polyolefin parts) to be selectively degraded, leading to the formation of ordered mesoporous polymers.

The starting materials used in the process can be commercial thermoplastic elastomers, which are widely available and cost-effective. This process can also readily incorporate post-industrial waste as well as precursors with varied form factors, including powders, beads, and 3D-structured starting materials, for example polypropylene filament. This one-step sulfonation-based crosslinking reaction in the presence of a free radical generator leads to crosslinked polymers with a large number of charged groups on the surface and defined mesopores.

Some systems have introduced micropores or macropores into ion exchange resins used for sorption, the ordered mesopores provided by this invention are observed to significantly improve adsorption performance against model organic pollutants as well as heavy metal ions. Furthermore, through this simple strategy the sorbent is crosslinked which imparts thermal stability. Existing technologies require additional processing steps to fabricate sorbent products with thermal stability. Moreover, the present method uses low-cost, commercially available TPE precursors. Due to this facile process and use of cheap precursors, the scaled production of these materials is anticipated to be commercially viable.

The thermoplastic elastomers are preferably formed of block copolymers, wherein the thermoplastic elastomer comprises two or more, or three or more block copolymers. Block copolymers are useful building blocks for the porous ionic polymers of the present invention for developing ordered cylindrical nanostructures. The block copolymers allow for the formation of ordered mesoporous morphologies in the resulting OMP products after sulfonation. Ordered mesoporous morphologies are defined by the presence of nanostructures that are uniform in size and shape. Preferably, the ordered mesoporous nanostructure is a self-assembled nanostructure, wherein the polymers/molecules spontaneously organize into ordered structures due to differences in the interactions of individual components and mixing parameters.

Suitable examples of the starting material that may be used in the process of the invention have a polyolefin backbone, including but not limited to homopolymers, blended materials, and copolymers. For example, the precursor material may be any one of the following: polypropylene, polyethylene and thermoplastic elastomers such as those comprising triblock polymers, wherein the first, second and third blocks may include a polyolefin, such as poly(styrene), poly(ethylene), poly(butylene), and combinations thereof. These thermoplastic elastomers may include polystyrene-block-poly(ethylene-ran-butylene)-block-polystyrene (SEBS), polystyrene-block-polyisoprene-block-polystyrene (SIS), and polystyrene-block-polybutadiene-block-polystyrene (SBS), for example.

The porous ionic polymers may be prepared via a one-step reaction comprising crosslinking one or more thermoplastic elastomers, for example, one or more copolymers comprising two or more blocks, or three or more blocks in the presence of one or more acids comprising sulfur, and one or more free radical generators. The crosslinking step may be carried out at a temperature of from about 100° C. to about 200° C., or from about 125° C. to about 175° C., or at about 150° C., for approximately 45 minutes to about 300 minutes, or from about 60 minutes to about 250 minutes, or from about 120 minutes to about 200 minutes, or for about 150 minutes.

The one or more free radical generators employed in the cross-linking step may be selected from dicumyl peroxide, benzoyl peroxide, azoisobutyronitrile, 2,2′-azobis(2-methylpropionitrile), potassium persulfate, lauroyl peroxide, cumene hydroperoxide, tert-butyl hydroperoxide, azobisisobutyronitrile, di-tert-butyl peroxide, methyl ethyl ketone peroxide, cumyl hydroperoxide, peroxyacetic acid, and hydrogen peroxide. Preferably, the free radical generator is dicumyl peroxide. The crosslinking step may be carried out using the free radical generator in a concentration of from about 0.001 wt. % to about 10 wt. %, or from about 0.05 wt. % to about 5 wt. %, or from about 0.01 wt. % to about 3 wt. %, based on a total weight of the combination of the one or more thermoplastic elastomers, the one or more acids comprising sulfur, and the one or more free radical generators.

The presence of a small concentration of a free radical generator allows for the formation of ordered mesopores while eliminating a calcination step. This is particularly advantageous since calcination is carried out at high temperatures and thus, the process of the present invention simplifies and reduces costs and energy use. Furthermore, the present process results in an ordered mesoporous material with a higher retention of functional groups, such as sulfuric acid groups, in the polymer framework. For example, the ordered mesoporous material provides a porous ionic polymer with repeat units derived from block copolymers or monomers, wherein 1-20% of the repeat units are functionalized with sulfonic acid groups, or about 3-13% of the repeat units are functionalized with sulfonic acid groups, or about 5-10% of the repeat units are functionalized with sulfonic acid groups.

The porous ionic polymer may be used in a water remediation device. In some embodiments, the porous ionic polymer further incorporates poly(styrene-block-poly(isoprene)-block-poly(styrene) (SIS), in an amount of from about 0.01 wt. % to about 20 wt. %, or from about 1 wt. % to about 10 wt. %, based on the total weight of the water remediation device. The presence of SIS results in a hierarchically macro/mesoporous crosslinked polymer (HMM).

In a suitable example, the method for preparing the ionic porous polymers, or ordered mesoporous polymers (OMP), of the present invention may be carried out by soaking thermoplastic elastomers, specifically poly(styrene)-block-poly(ethylene-ran-butylene)-block-poly(styrene) (SEBS), in concentrated sulfuric acid at 150° C. for 75 minutes in the presence of a free radical generator, for example, 0.1-1 wt. % dicumyl peroxide (DCP). After the crosslinking reaction, the remaining acid was removed, and the product is washed in water. The resulting material typically has 6-10 mol % sulfonation, as determined by titration, which imparts ion exchange capability.

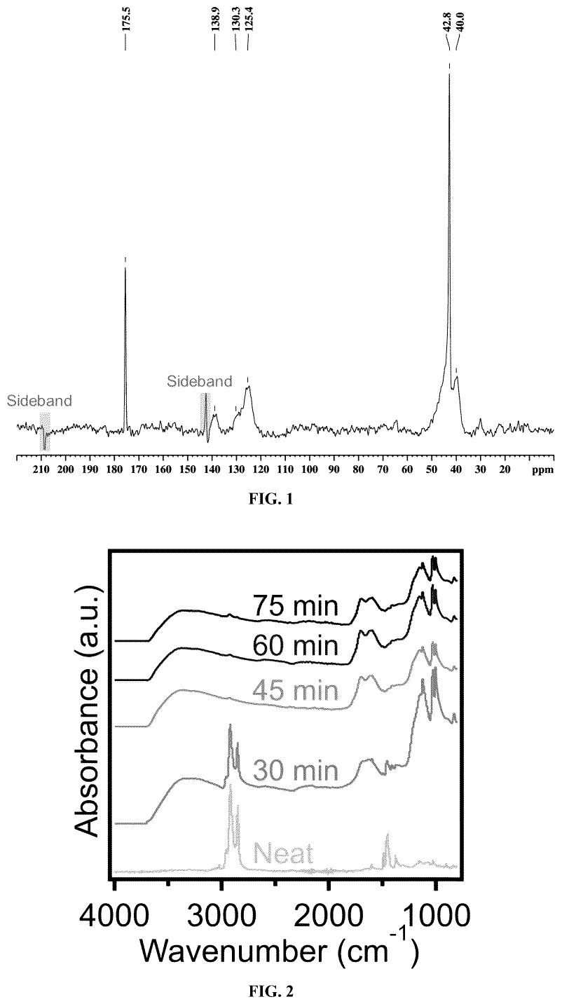

The structure of the resulting material can be assessed through solid-state carbon nuclear magnetic resonance, for example, as seen in FIG. 1, where methylene carbons associated with the polymeric backbone are observed between 40 ppm and 46 ppm and broad peaks at ˜125 and 140 are associated with unsaturated carbons including aromatic groups and ketones. Moreover, the structure and chemical composition of the SEBS was further probed as a function of reaction time as shown in FIG. 2. Several shifts in characteristic peaks were observed, including the appearance of broad band at ˜3400 cm⁻¹) associated with hydroxyl stretching and bands at 1030 cm⁻¹ and 1010 cm⁻¹ associated with sulfonation of the PEB and PS backbone, respectively. In addition, formation of alkene groups is suggested with the appearance of a band at 1600 cm⁻¹ as well as the reduced intensity of alkyl stretching (2910 cm⁻¹ and 2850 cm⁻¹).

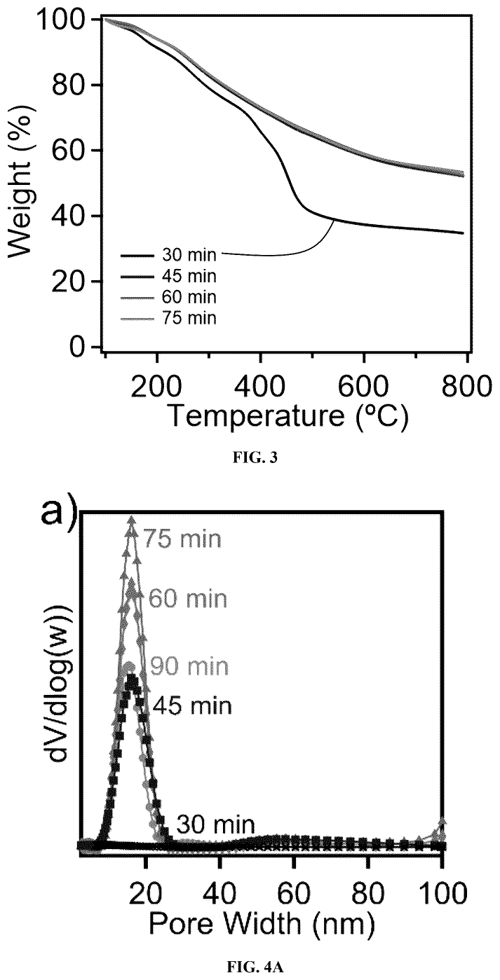

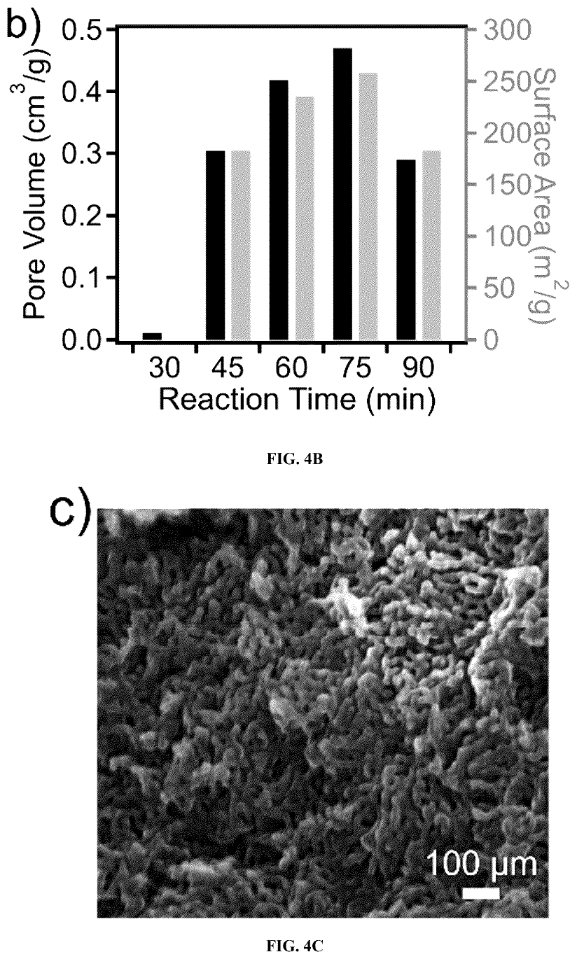

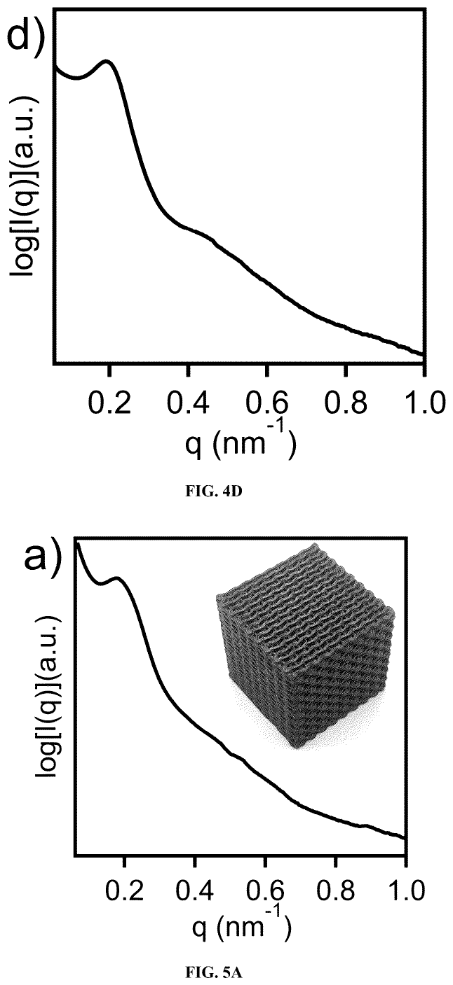

Thermogravimetric analysis (TGA) under nitrogen environment of SEBS after conversion to OMP showed that the samples are heavily crosslinked, with significant char yields after treatment at 800° C. (FIG. 3). Furthermore, the resulting material has an ordered mesoporous morphology, as confirmed by liquid nitrogen physisorption measurements (FIG. 4A) and scanning electron microscopy (SEM) (FIG. 4C). The resulting surface areas and pore volumes seen in FIG. 4B confirm the sorption capability of these materials.

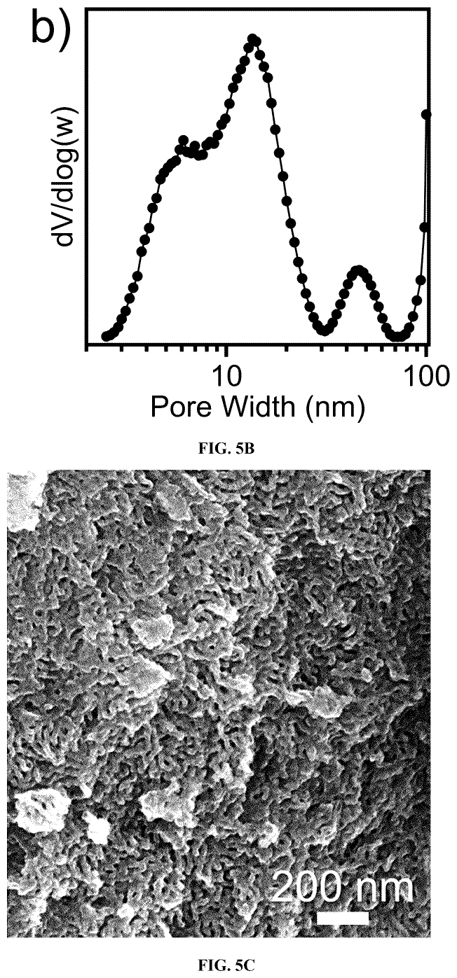

Small angle x-ray scattering (FIG. 4D) confirmed the retention of ordered nanostructure after conversion to OMP, with a domain spacing of 32.0 nm. Furthermore, the applicability of this process to three-dimensionally structured precursors has also been demonstrated, where a 3D-printed precursor was converted to OMP with retention of the ordered nanostructures (FIG. 5A), and the presence of mesopores was confirmed through liquid nitrogen physisorption measurements (FIG. 5B) and SEM (FIG. 5C).

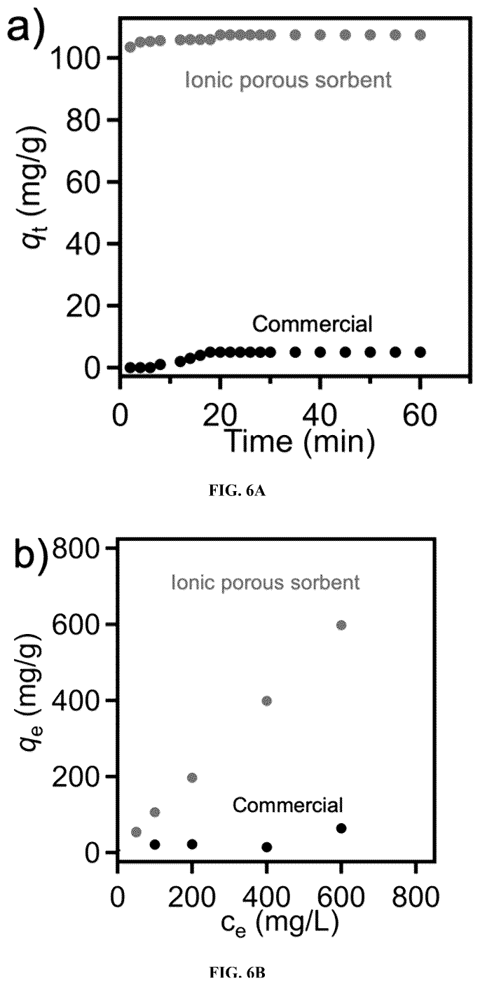

After fabrication, the 75-minute reaction sample was chosen for dye adsorption experiments in comparison with a control for the uptake of the model organic pollutant, methylene blue. Adsorption kinetics were assessed with an initial concentration of 100 mg/L (FIG. 6A), and adsorption capacity was determined at various contact times. It was observed that the OMP captured all of the methylene dye within the first 3 minutes of contact time. In contrast, a sulfonated SEBS prepared in the absence of the free radical generator, which did not have mesopores and served as an analog to conventional ion exchange resins, exhibited minimal methylene dye capture during the same 3-minute time period. As a result, the present method provides sorbent products with ˜50 times higher sorption capacity and ˜10 times faster kinetics compared to current commercially sorption materials.

Adsorption capacities were assessed at equilibrium for various dye concentrations (50-400 mg/L) (FIG. 6B). The OMP achieved complete removal of dye (>99%) at all concentrations whereas the sulfonated SEBS control again demonstrated minimal dye capture. Due to the OMP's rapid pollutant capture kinetics as well as its high adsorption capacity, the OMP offers superior properties suitable for use in efficient water remediation devices. Moreover, the simplified fabrication process makes these OMPs a commercially viable alternative to conventional sorbents.

### EXAMPLES

### Example 1—Solid-State Transformation of Thermoplastic Elastomers to High-Performance Mesoporous Sorbents for Water Remediation

This example demonstrates the simple and robust method of the present invention for producing ordered mesoporous polymers (OMPs) from commodity thermoplastic elastomers (TPEs) through a one-step, solid-state reaction. Specifically, when exposed to sulfuric acid and radical species at elevated temperatures, polystyrene-block-poly(ethylene-ran-butylene)-block-polystyrene (SEBS) was found to undergo selective cleavage of minority polystyrene (PS) domains, while the majority of the poly(ethylene-ran-butylene) (PEB) phase was crosslinked and functionalized with sulfonic acid groups. The role of radical species and sulfuric acid on PS cleavage as well as its impacts on chemical composition, nanostructure, thermal stability, and pore textures were systematically investigated. To assess the versatility of this process, several waste TPE blends as well as a random block copolymer, acrylonitrile butadiene styrene (ABS), were upcycled to make porous polymer materials. Due to their ionic nature and their ordered mesoporous morphology, the fabricated OMPs demonstrated excellent sorption performance against several model organic micropollutants in aqueous media.

### 1. Materials

Dicumyl peroxide (DCP), azobisisobutyronitrile (AIBN), SEBS [Mₙ: 89,000 g/mol, Ð: 1.56, ϕ_{PS}=0.20; M_{w}: 118,000 g/mol, Ð: 1.59, ϕ_{PS}=20 wt. %], toluene, hydrochloric acid (HCl; 37%), sodium chloride (NaCl, ACS grade), sodium hydroxide (NaOH, ACS grade), sulfuric acid (98%), methylene blue hydrate, rhodamine B, acid orange 7, crystal violet, and polystyrene (Mₙ: 35,000 g/mol) were purchased from Sigma-Aldrich. Acrylonitrile butadiene styrene (ABS) was purchased from Ultimaker (S-series, white). A commercial ion exchange sorbent was purchased from U.S. Water Filters and used as a commercial benchmark for comparative analysis. A Milli-Q IQ 7003 water purification system (Millipore Sigma) was used to obtain deionized (DI) water.

### Ordered Mesoporous Polymers Synthesis

To synthesize OMP from TPEs, a SEBS:DCP blend was first prepared by dissolving SEBS at 8 wt. % and DCP at 0.08 wt. % in toluene, drop-casting onto petri dishes, and allowing the mixture to dry at room temperature overnight. SEBS:DCP films were removed and submerged into concentrated sulfuric acid at 150° C. for various amounts of time. After reaction, films were washed three times with DI water to ensure complete removal of byproducts and residual acid followed by vacuum drying overnight at 45° C. For direct addition of DCP into the reaction flask which allows for a more streamlined process, 0.07 wt. % DCP (based on the total weight of acid, radical generator, and sample) was added to a 250 mL round bottom flask containing 10 g of SEBS and 50 mL of sulfuric acid which was reacted for 2 h at 150° C.

To examine the use of other radical initiators, 0.07 wt. % AIBN was added to a 250 mL round bottom flask containing 10 g of SEBS and 50 mL of sulfuric acid and reacted for 2 h at 150° C. For conversion of ABS to porous polymer, 0.07 wt. % DCP was added to a 250 mL round bottom flask containing 10 g of SEBS and 50 mL of sulfuric acid and reacted for 2 h at 150° C. This method was also extended to various waste SEBS materials containing unknown compositions of dyes and other additives. Their conversion to OMP was performed following the same treatment method described above, involving the direct addition of DCP to sulfuric acid.

### Characterization

Fourier transform infrared (FTIR) spectroscopy was carried out with a Thermo Scientific Nicolet 6700 with a Smart iTR attenuated total reflection accessory, a 4 cm⁻¹ resolution averaged over 32 scans with a scan range of 4000-600 cm⁻¹. Mohr's titrations were carried out to assess the degree of sulfonation,¹ where 0.1 g of sample was placed in 0.4 M sodium chloride (NaCl) solution for 72 h in order to exchange sulfonic acid group H⁺ ions with Na⁺. After this, samples were removed and the solution was titrated with sodium hydroxide (0.026 M NaOH) to pH 7 and the degree of sulfonation was determined through the amount of NaOH used and by applying the following equation:

$$Degree of sulfonation = \frac{{V}_{NaOH} {M}_{NaOH}}{\frac{{m}_{SEBS}}{{M}_{w , SEBS}} N}$$

where M_{w,SEBS} is the polymer's molecular weight, m_{SEBS} is the mass of sample placed in the NaCl solution, N is the number of repeat units, M_{NaOH} is the NaOH solution molarity, and V_{NaOH} is the amount of NaOH used to neutralize the solution.

A Thermo Fisher ESCALAB Xi+ spectrometer was utilized for X-ray photoelectron spectroscopy (XPS) experiments, with a monochromatic Al Kα X-ray source, a 3×10⁻⁷ mbar base pressure, and a takeoff angle of 90°. Thermo Fisher Avantage software was used for data analysis. Gel fraction was assessed by exposing 0.3 g of sample to 10 g of toluene for 24 h at room temperature followed by filtration and vacuum drying overnight at 45° C. The insoluble fraction was then determined by comparing the initial mass to the mass of the dried sample.

A TA Instruments Discovery TGA 550 was used for thermogravimetric analysis (TGA) measurements with a heating rate of 10° C./min up to 800° C. under a nitrogen environment. Nitrogen physisorption experiments were conducted with a TristarII 3020 (Micromeritics) at 77K, with pore size distributions determined with non-local density functional theory (NLDFT) and surface areas with the Brunauer-Emmett-Teller (BET) model. A Zeiss Ultra 60 field-emission scanning electron microscope (SEM) was used to probe sample morphologies with a 10 kV accelerating voltage. Small angle X-ray scattering was carried out at the 11-BM Complex Materials Scattering beamline at Brookhaven National Laboratory (National Synchrotron Light Source II), with a 12 keV X-ray energy and a 5.05 sample-to-detector distance. Domain spacing was determined with the following equation: d=2π/q*.

Dye studies were carried out with methylene blue, rhodamine b, acid orange, and crystal violet to assess the adsorption performance of OMP and a commercial ion exchange resin. A 50 mg/L dye concentration in 250 mL DI water was prepared for all studied dyes and 20 mL was exposed to 5 mg of sample followed by shaking for 48 h. A Genesys 30 visible spectrometer (Thermo Scientific) was used to assess the maximum absorbance of the solution before and after sorbent exposure. Methylene blue was chosen for subsequent kinetic and equilibrium measurements. Specifically, 5 mg of sample was introduced to 20 mL of dye solution (100 mg/L) and aliquots were collected at various time intervals. The quantity adsorbed (qₜ) was then determined with the following equation:

$${q}_{t} = \frac{( {C}_{o} - {C}_{e} ) * V}{M}$$

where M is the adsorbent mass (g), V is the solution volume (L), C₀ is the equilibrium dye concentration (mg/L) and Cₑ is the initial dye concentration (mg/L).

### 2. Results and Discussion

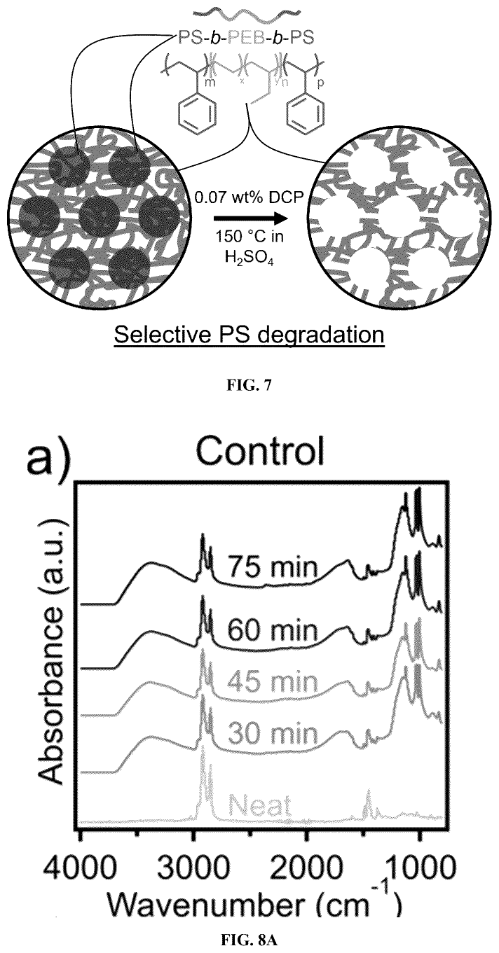

FIG. 7 depicts the present invention's process of solid-state transformation of styrenic-based block copolymers (BCPs), such as SEBS, into porous sorbents through exposure to sulfuric acid and radical initiators at elevated temperatures, resulting in selective cleavage of PS blocks. In addition to mesopore formation within the polymer matrix, it was found that the presence of radical species promotes sulfonation-induced crosslinking of the majority BCP phase, which also installs sulfonic acid groups onto the polymer backbone. The present invention demonstrated that blending with a radical initiator (DCP) lead to the formation of OMP with reduced reaction times and enhanced pore textures. Moreover, it was demonstrated that radical initiators can be directly added to the reaction flask to enable scaled OMP production. Unlike methods requiring additional steps for selective domain removal, such as solvent extraction, sequential UV exposure, and calcination, the present method by employing a one-step solid-state process efficiently converts various styrenic-based BCPs into OMP, yielding high-performance sorbents at lower cost and with less energy consumption.

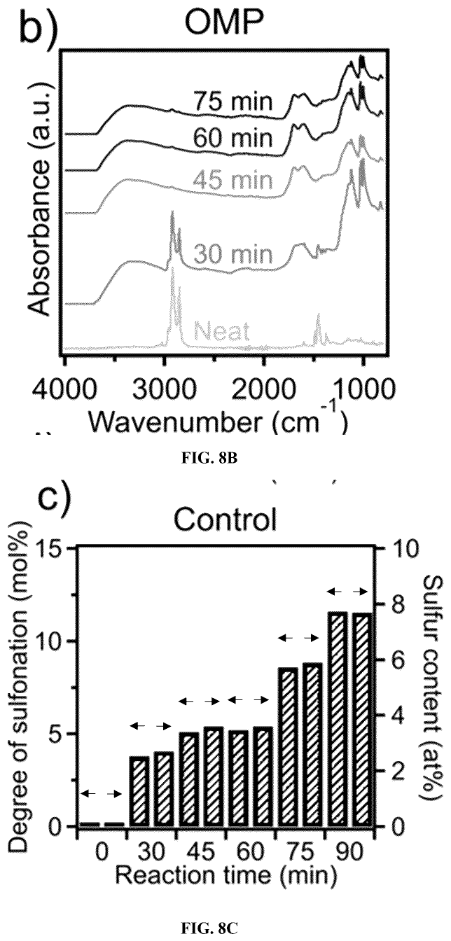

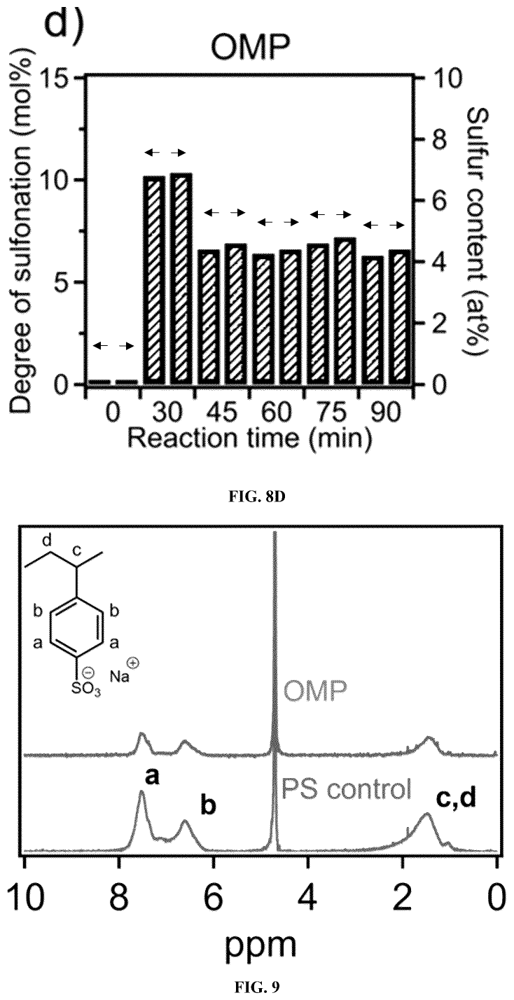

To assess how the incorporation of radical initiators into SEBS influences the kinetics of sulfonation-induced crosslinking of a polyolefin matrix, a model system was first prepared by blending with 1 wt. % DCP. FTIR spectroscopy was used to monitor reaction progress for the neat SEBS (FIG. 8a) and the SEBS:DCP blend (FIG. 8b) after reaction at 150° C. Several changes in the chemical composition were observed in both systems, including the appearance of a broad band at ˜3400 cm⁻¹ associated with hydroxyl stretching and bands at 1030 cm⁻¹ and 1010 cm⁻¹ associated with sulfonation of the PEB and PS backbones, respectively. These bands appeared within 30 min for both systems, indicating rapid sulfonation of both PEB and PS blocks. In the neat SEBS system, bands associated with alkyl stretching along the polyolefin backbone (2910 cm⁻¹ and 2850 cm⁻¹) only slightly decreased with increasing reaction time up to 75 min, while the SEBS:DCP blend showed rapid decay which became nearly absent after 45 min. This behavior, coupled with the appearance of a pronounced band at 1600 cm⁻¹, correlated to the formation of alkene groups at lower reaction times compared to the SEBS control sample, indicating that the introduction of radical initiators accelerated sulfonation-induced crosslinking. Moreover, PS domain removal in the SEBS:DCP system is suggested by the significant reduction of the aromatic ring mode band at 1492 cm⁻¹ at 45 min, which remained largely unaffected in the neat SEBS system at 75 min. Additionally, the two bands at 1030 cm⁻¹ and 1010 cm⁻¹ retained significant intensity and remained fairly distinct in the neat SEBS, while the SEBS:DCP systems showed a reduced intensity and partial merging of the two bands at longer reaction times. This phenomenon indicated a reduction in the relative amount of sulfonated PS within the SEBS system. Ultimately, incorporation of radical species results in chemical composition changes that suggest accelerated crosslinking kinetics and removal of PS domains. Furthermore, the aqueous solution after SEBS:DCP crosslinking, along with a PS control, was neutralized to pH 7 with sodium hydroxide (NaOH), dried, and probed through ¹H NMR (FIG. 9). It was found that the dried reaction solutions for both the sulfonated PS control and the SEBS:DCP exhibited identical broad peaks corresponding to a PS backbone and aromatic protons.

The ionic character of the neat SEBS and SEBS:DCP blends after the reactions was then assessed through Mohr's titrations and XPS survey scans as depicted in FIGS. 8C and 8D. The neat SEBS's degree of sulfonation gradually increased to 3.8 mol % after 30 minutes, then increased to 5.2 mol % after 60 min, and then plateaued at 11.7 mol % after 90 min. Moreover, the sulfur content from XPS measurements showed a similar trend, with 2.7 at %, 3.6 at %, and 7.7 at % after 30 min, 60 min, and 90 min, respectively (See FIG. 8C). This gradual increase in sulfonic acid group content has been previously observed in sulfonation-induced crosslinking of bulk SEBS. In contrast, the SEBS:DCP achieved a maximum sulfonation degree of 10.2 mol % and a maximum sulfur content of 8.4 at % at 30 minutes, which decreased to 6.6 mol % and 6.0 at %, respectively, at 45 min and remained relatively stable with longer reaction times. This shift in behavior could be correlated to the rapid sulfonation kinetics observed through FTIR spectra, indicating a maximum in sulfonic acid character at 30 min. After 45 min, this ionic character decreased by 35% and 29%, respectively, which may be attributed to the removal of sulfonated PS content, which is consistent with the PS fraction (ϕ_{PS}=0.20) within the SEBS system.

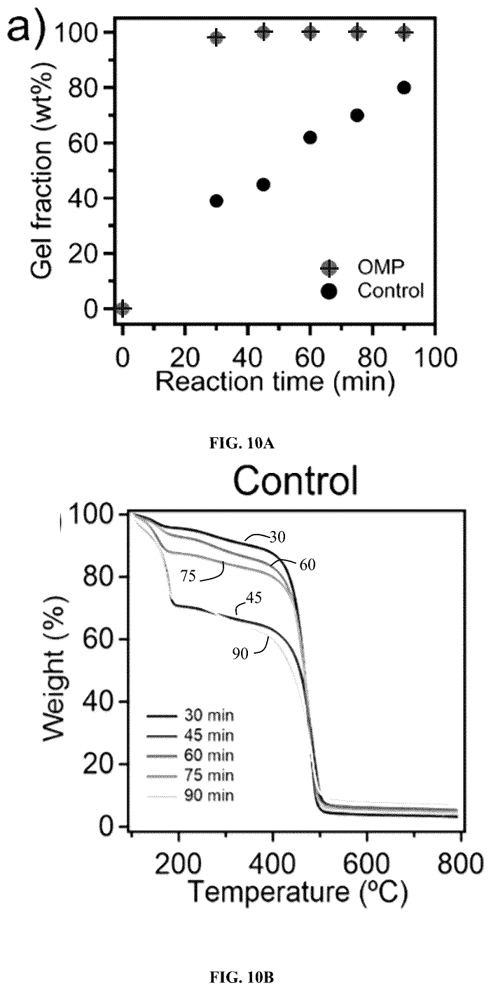

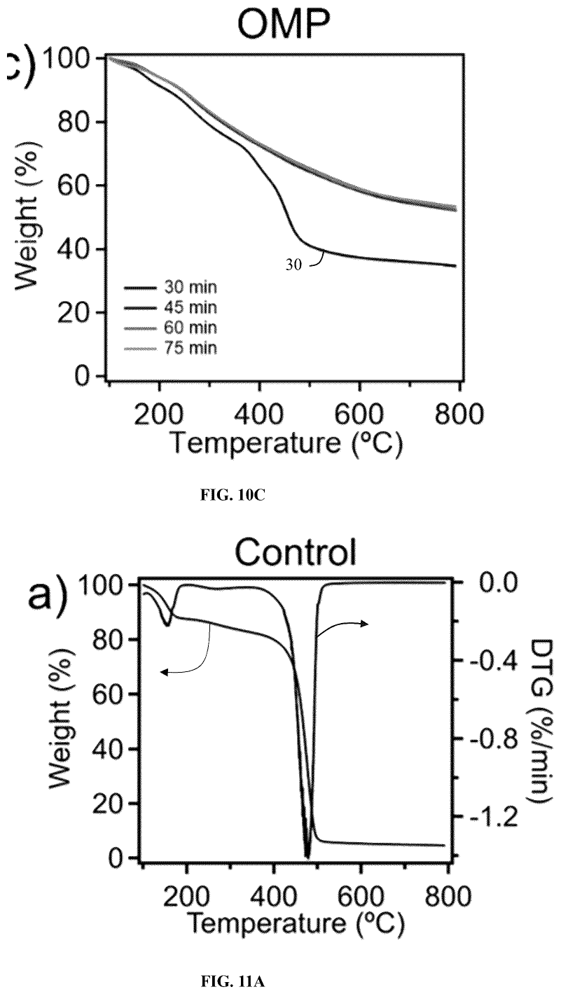

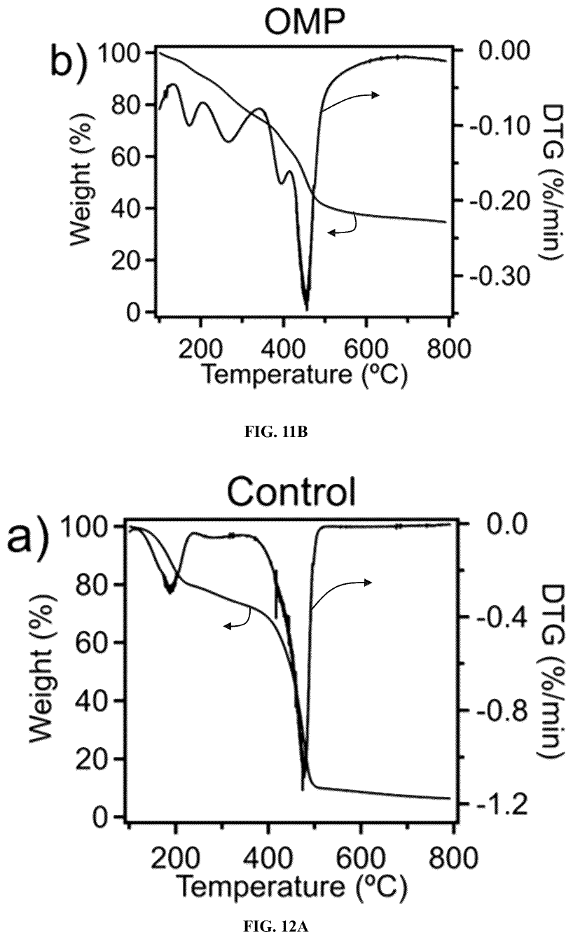

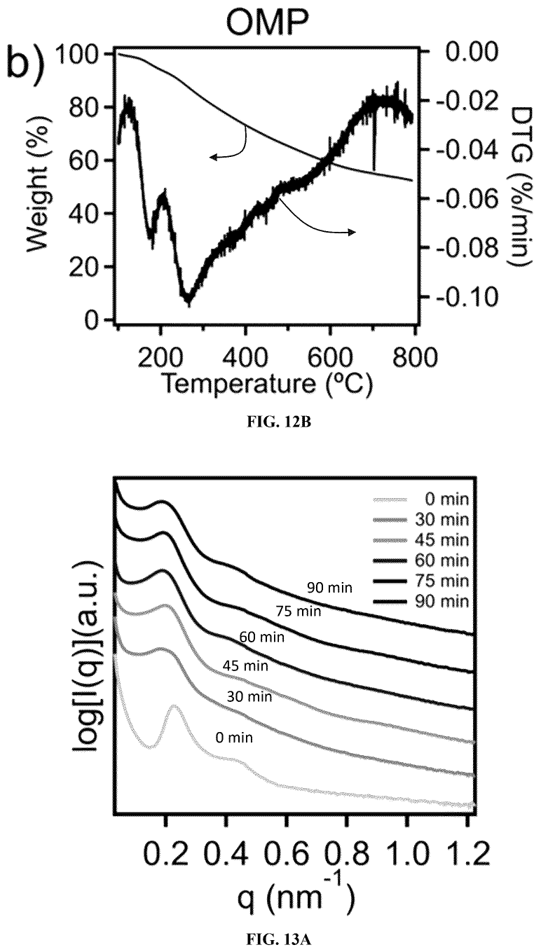

The degree of crosslinking was then probed through gel fraction measurements as shown in FIG. 10A, where the neat SEBS showed a gradual increase in insoluble content of from 39 wt. % to 62 wt. %, and to 80 wt. % after 30 min, 60 min, and 90 min, respectively. However, incorporation of DCP resulted in further increased crosslinking kinetics with a 98% insoluble fraction after 30 min which reached 100 wt. % after 45 min. TGA up to 800° C. was performed under nitrogen to determine the carbon yield of neat SEBS after various reaction times, where a relatively low yield (7.1 wt. %) was observed after 90 min (FIG. 10B). In comparison, the incorporation of 1 wt. % DCP lead to 35 wt. % carbon yield after 30 min with a plateau of 58 wt. % after 45 min (FIG. 10C). In comparison to bulk SEBS, which exhibited a maximum carbon yield of 48 wt. %, this ˜10 wt. % increase in SEBS:DCP carbon yield may be attributed to PS cleavage, which undergoes decomposition during heating. To probe this further, differential thermograms of the neat SEBS and SEBS:DCP blend after 30 min and 75 min of reaction time are shown in FIGS. 11A and 11B and FIGS. 12A & 12B. The control showed minimal change between the two reaction times, with two distinct degradation events at ˜165° C. and ˜480° C., corresponding to sulfonated PEB and PEB, respectively. In comparison, the addition of DCP lead to several degradation events after 30 min of reaction time, in addition to sulfonated PEB and PEB, including sulfonated PS at ˜287° C. and PS at ˜393° C. After 75 min of reaction time, only two degradation events were observed at 200° C. and 293° C., corresponding to sulfonated PEB and sulfonated PS, respectively. The significant reduction in the intensity of these peaks at both reaction times further indicates the acceleration of sulfonation-induced crosslinking and the cleavage of most PS units from the polymeric backbone.

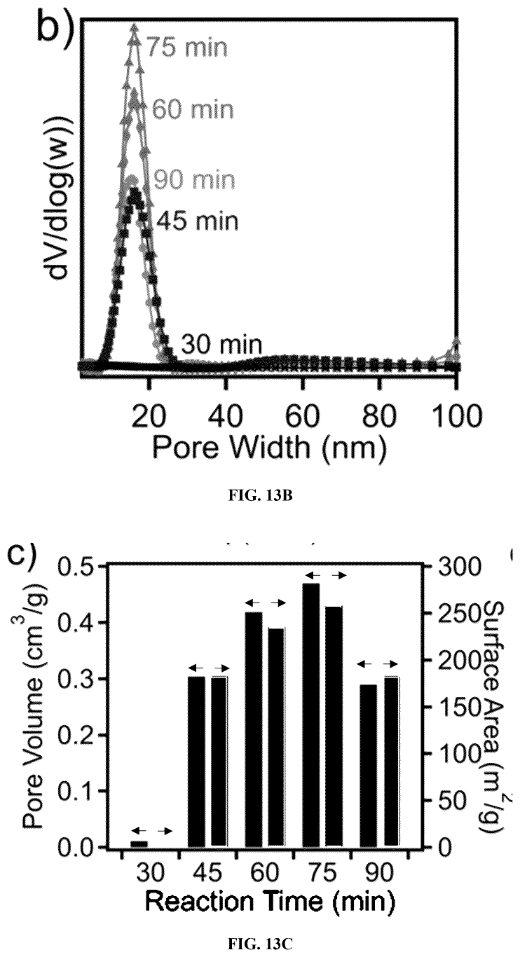

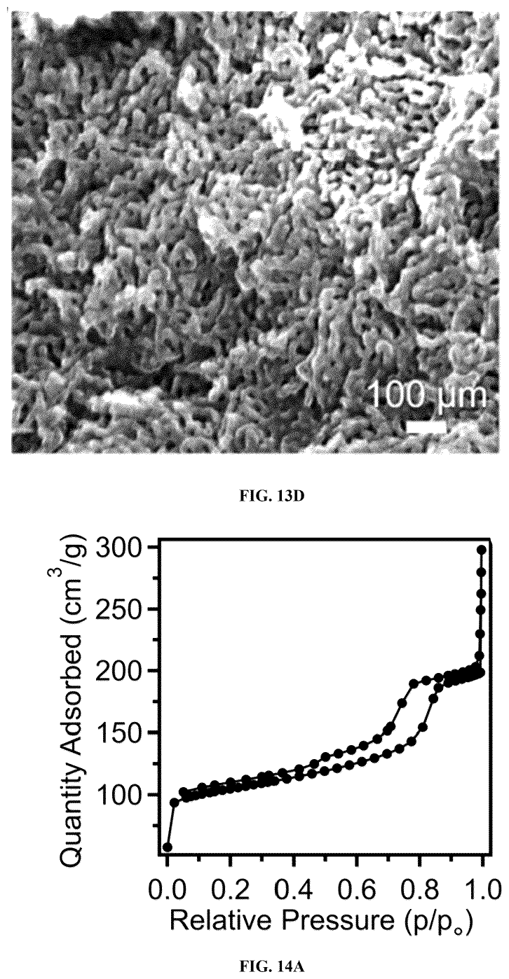

SAXS measurements were conducted to monitor how the addition of a radical initiator influences the SEBS nanostructure during reaction, as depicted in FIG. 13A. Both the neat SEBS and SEBS:DCP blend exhibited increased domain spacings and slight broadening of the primary peak, due to reaction-induced swelling of the PS and PEB blocks. The domain spacing of the neat SEBS increased from 27.3 nm to 31.7 nm after 30 min of reaction time and up to 32.1 nm after 90 min, while the SEBS:DCP increased from 27.3 nm to 32.7 nm after 30 min of reaction time and remained relatively consistent with longer reaction times. However, the full width at half maxima (FWHM) increased significantly for the neat SEBS, from 0.0533 nm⁻¹ to 0.217 nm⁻¹ after 30 min of reaction time and gradually decreased with increasing reaction time down to 0.108 nm⁻¹ after 90 min. In contrast, the SEBS:DCP blend reached a much lower maximum FWHM of 0.096 nm⁻¹ after 30 min of reaction time, which fluctuated ˜0.075 nm⁻¹ with greater reaction time. The rapid domain spacing expansion and plateau, along with the reduced broadening of the primary ordering peak, suggest rapid crosslinking can kinetically limit the reaction-induced nanostructural change and result in an improved degree of ordering.^{4,6} Nitrogen physisorption isotherm-derived pore size distributions in FIG. 13B show the absence of pores after 30 min of reaction time for the SEBS:DCP blend, though increasing reaction times resulted in a type IV isotherm with a pore size distribution centered at 16.1 nm with increasing peak intensity up to 75 min. FIG. 13C presents the corresponding pore volumes and surface areas, which gradually increase up to 75 min, with a maximum pore volume of 0.470 cm³/g and a surface area of 259 m²/g. A slight reduction was observed after 90 min of reaction time, which may be due to partial degradation associated with radical species and sulfuric acid over exposure. The OMP's uniform mesopores were then further probed through SEM imaging in FIG. 13D, with an average pore size of 15.3 nm.

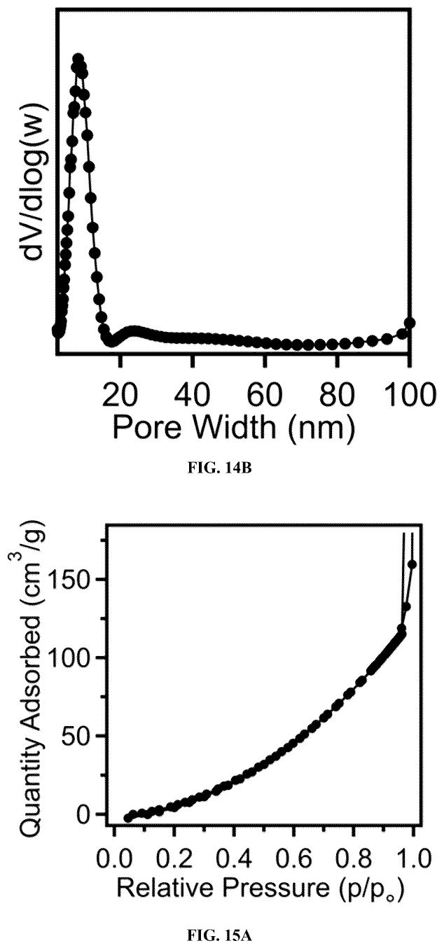

To evaluate the generalizability and scalability of this process, a scaled OMP synthesis was carried out with 10 g of 89 k g/mol SEBS with direct addition of DCP (0.07 wt. %; based on the total weight of acid, radical generator, and sample) into the reaction flask, rather than blending with SEBS. Though a slightly longer reaction time was necessary (2 h) compared to the SEBS:DCP blend, the nitrogen physisorption isotherm and pore size distribution in FIGS. 14A and 14B demonstrated consistent surface areas (291 m²/g) and pore volumes (0.399 cm³/g). It was found that that the lower molecular weight SEBS resulted in OMP with a slight reduction in the average pore size (9.3 nm). By extending to additional SEBS precursors and directly adding radical initiators to the reaction flask, the versatility and robustness of the present method was demonstrated.

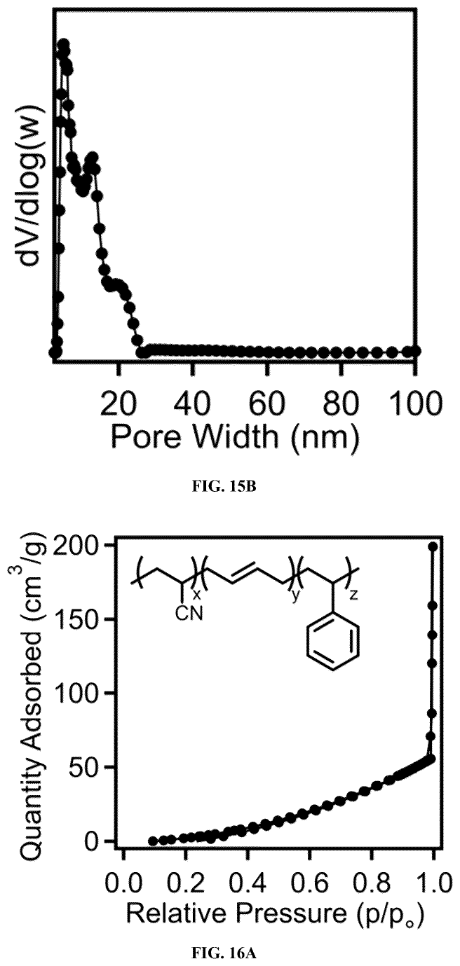

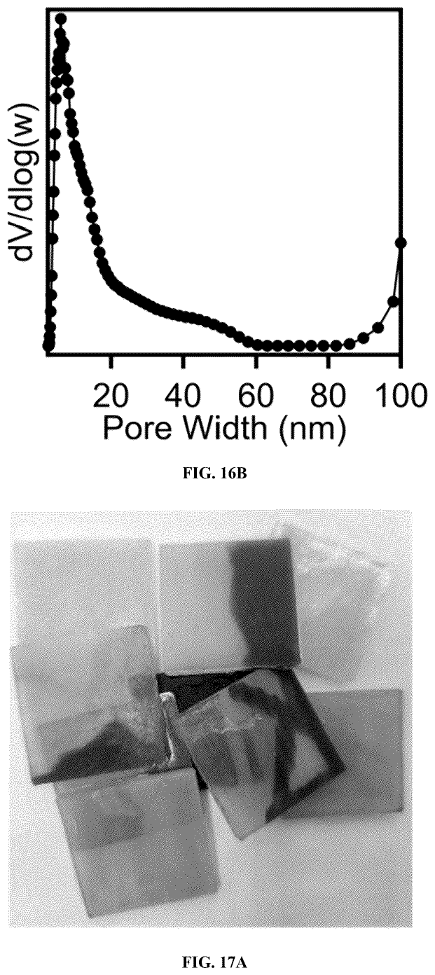

The radical initiator was varied to further evaluate the generalizability of this process with 0.07 wt. % AIBN, which resulted in a slightly reduced surface area (70 m²/g) and pore volume (0.182 cm³/g), as well as a broad pore size distribution with peaks at 5.1 and 12.9 nm, and a shoulder at ˜20 nm (FIGS. 15A & 15B). Furthermore, the one-step method was applied to ABS for conversion to porous polymer following identical reaction conditions resulting in a surface area of 138 m²/g, a pore volume of 0.126 cm³/g, and a broad pore size distribution centered at 6.3 nm (FIGS. 16A & 16B).

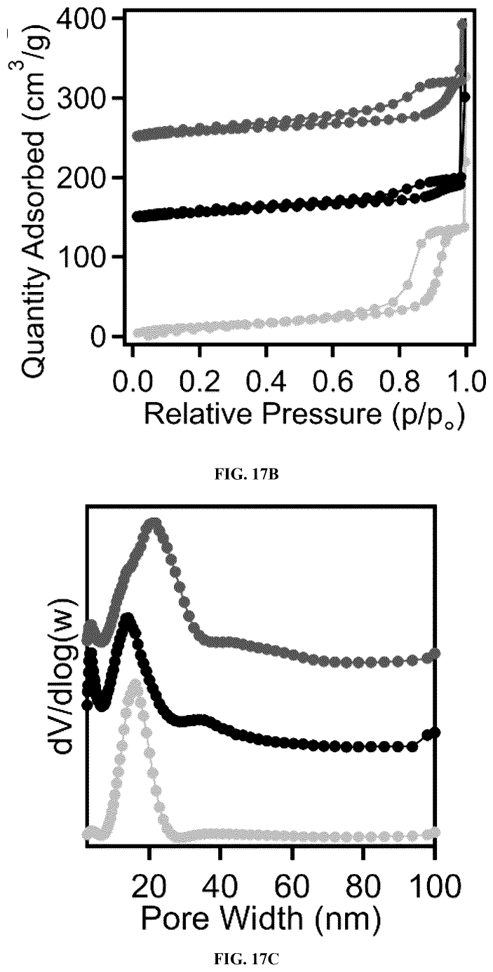

While BCPs with defined morphological features and nanostructures represent a significant portion of total plastics production, conventional plastic recycling pathways often sacrifice these features during reprocessing.⁷ As this solid-state process was found to retain nanostructural features of various BCP systems, the ability of this strategy to address contaminated and waste BCP feedstocks is very promising. Three different SEBS wastes containing varied colorants and additives were intermingled at varying amounts as displayed in FIG. 17A. After 2 h at 150° C. with 0.07 wt. % DCP, the three blends were found to exhibit mesoporous morphologies, determined by nitrogen physisorption measurements (FIGS. 17B and 17C). Surface areas were found to decrease compared to the neat system (40 m²/g for the green blend, 41 m²/g for the black blend, and 48 m²/g for the yellow blend), while pore volumes varied depending on each blend (for example, 0.130 cm³/g for the green blend, 0.084 cm³/g for the black blend, and 0.224 cm³/g for the yellow blend). Interestingly, the pore size varied slightly between blends ranging from no difference compared to the initial system to increasing and decreasing by ˜4 nm (16.1 nm for the green blend, 13.5 nm for the black blend and 20.9 nm for the yellow blend). While the macrostructure of the waste is partially retained after conversion to OMP, with slight distortion, samples can be simply processed to fine powder for use as water purification sorbents.

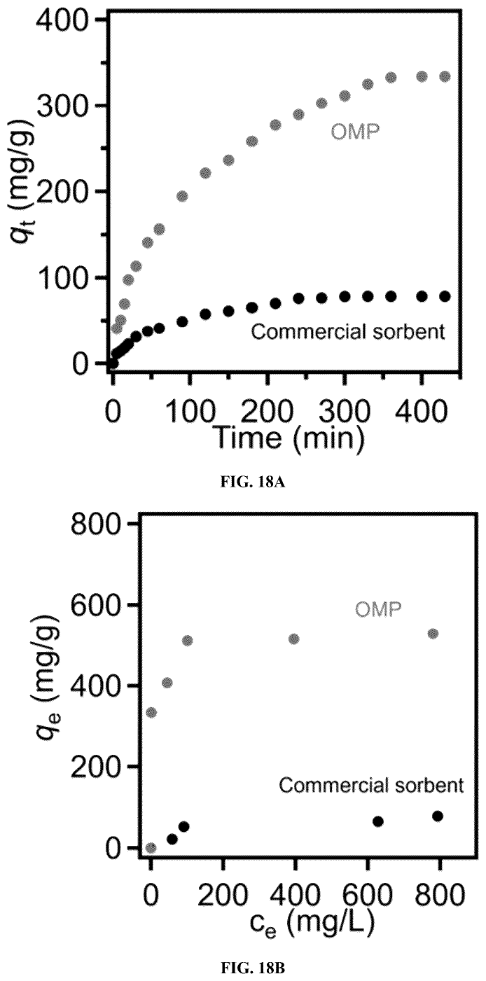

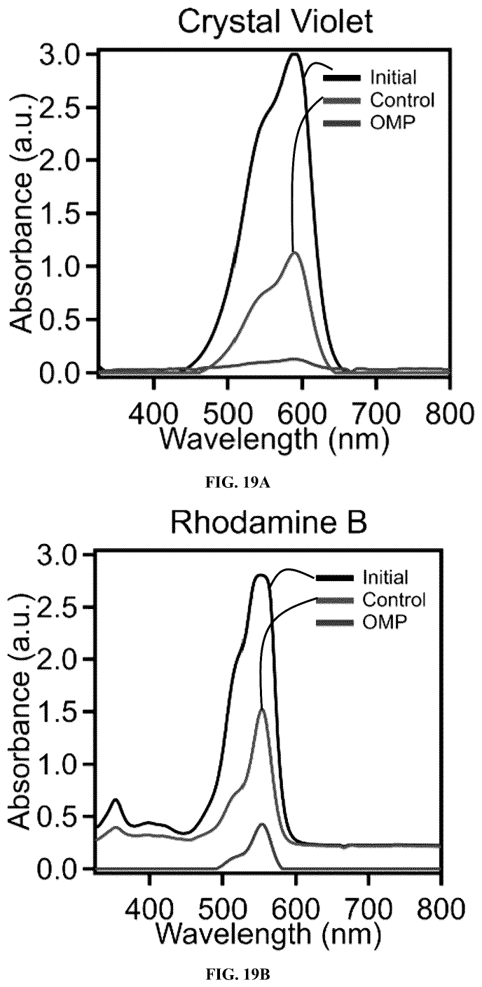

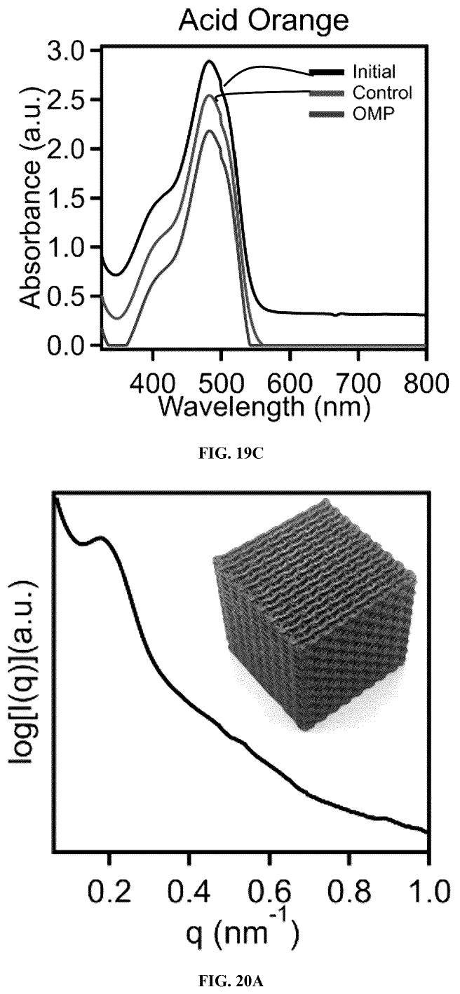

Porous polymers have been heavily investigated as sorbents for water purification for removing various toxic species from aqueous environments. The OMPs prepared in this example exhibited each of ionic character, ordered mesopores, and high degrees of crosslinking. Dye adsorption studies were conducted comparing OMP to a commercial ion exchange sorbent with a model system, methylene blue hydrate. FIG. 18A shows the adsorption kinetics of both sorbents, where the OMP had a higher equilibrium adsorption capacity (308 mg/g) compared to the commercial sorbent (78 mg/g), reached within 5 h of contact time. The adsorption equilibrium at various dye concentrations (50 mg/L-800 mg/L) were investigated in FIG. 18B, where the OMP exhibited a larger adsorption equilibrium across the studied dye concentrations, reaching 530 mg/g, while the commercial sorbent reached a maximum of 85 mg/g. Furthermore, three additional model dyes were examined: rhodamine B, acid orange 7, and crystal violet. Specifically, a 50 mg/L dye concentration was selected, and adsorption was assessed after 48 h of contact time in FIGS. 19A-19C. The increased reduction of UV-vis sorption peaks indicated a greater content of dyes were removed from the aqueous composition. From these results it was determined that OMP exhibited improved adsorption capabilities for all three dyes compared to the commercial ion exchange sorbent.

### Example 2

Ordered mesoporous materials (OMMs) have significant potential for a wide range of applications, but their large-scale implementation has been largely constrained by challenges in assembling them into diverse form factors. Specifically, most methods reported to date can readily prepare OMMs with tunable pore textures as particles and films. However, there are very few approaches that enable the direct fabrication of OMMs into complex macroscopic structures, which is an essential capability for facilitating a broad range of practical applications. The methods discussed herein provide a robust manufacturing platform for using commodity thermoplastic elastomers (TPEs), precursors and simple processes to directly fabricate ordered mesoporous materials (OMMs) with on-demand control over their 3D structures enabled by additive manufacturing (AM). The macroscopic dimensions, nanostructure, chemical composition, and morphology of samples were systematically investigated throughout the fabrication process. Ordered mesoporous polymer (OMP) 3D-structures of the present invention are suitable for direct fabrication through selective removal of polystyrene domains, facilitated by a co-presence of sulfuric acid and radical species. The resulting materials retain ordered nanostructures and macroscopic features after mesopore formation. Overall, the present invention offers an innovative and cost-effective route to manufacture OMMs with control over both macrostructure and nanopore textures, which are essential to further advance their applications.

### Materials

Polystyrene-block-poly(ethylene-ran-butylene)-block-polystyrene (SEBS) [Mₙ: 89,000 g/mol, Ð: 1.56, ϕ_{PS}=0.20], sulfuric acid (98%) and dicumyl peroxide (DCP), were purchased from Sigma-Aldrich. Polypropylene (PP) filament (FL100PP) was purchased from Braskem. Deionized (DI) water was obtained by passing tap water through a Milli-Q IQ 7003 (Millipore Sigma) water purification system.

### OMP Fabrication

SEBS powder was first converted into 2.85 mm filament with a Process 11 parallel twin-screw extruder (Thermo Scientific) connected to a spooler (Filabot). The key processing parameters included a feed port set to 215° C., all 5 zones set to 235° C., and a screw speed of 100 rpm. SEBS and PP filament were then pelletized and a 2.85 mm filament was prepared for a series of SEBS:PP blends (20 wt. %, 40 wt. %, 60 wt. %, and 80 wt. %) by compounding with the Process 11 parallel twin-screw extruder connected to a spooler with the same processing parameters as above. Fused filament fabrication (FFF) 3D-printing of the SEBS:PP blends was carried out with a LulzBot Mini and an Ultimaker S5 with a printing bed temperature of 80° C. with Magigoo PP bed adhesive, a nozzle temperature of 240° C., and a printing speed of 35 mm/s. While several structures were investigated in this study, a cylinder structure was selected as a model system with 15 mm diameter, 15 mm height, and a 50% infill density.

To fabricate 3D-structured OMPs, fused filament fabrication (FFF)-printed SEBS:PP samples (prepared from a 65:35 wt. % SEBS:PP blend) were first completely submerged into concentrated sulfuric acid. After this, 1 wt. % of dicumyl peroxide, based on the total weight of sample, acid, and radical generator, was included in the reaction flask which was then placed into a muffle furnace (Thermo Scientific Thermolyne F6010) set to 135° C. for varying amounts of time. After reaction, samples were then removed from reaction vessels by passing through a glass fritted funnel, washed with DI water three times to remove residual acids and reaction byproducts, and dried over vacuum at 50° C. overnight. Dried materials were carbonized by heating to 600° C. with a rate of 1° C./min, followed by heating to 800° C. with a rate of 5° C./min in an Across international TF1400 tube furnace under a nitrogen atmosphere.

### Characterization

A Nicolet 6700 Fourier transform infrared (FTIR) spectrometer (Thermo Scientific) equipped with an attenuated total reflection accessory (Smart iTR ATR) was utilized to probe chemical compositions of the samples, with a scan range of 4000-600 cm⁻¹ and an average of 32 scans with a 4 cm⁻¹ resolution. Morphologies of the prepared samples were further probed through scanning electron microscopy (SEM) with a Zeiss Ultra 60 field-emission SEM (13 kV accelerating voltage). To assess the nanostructures of prepared samples, small angle X-ray scattering was conducted at Brookhaven National Laboratory within the National Synchrotron Light Source II (11-BM Complex Materials Scattering beamline) with a sample-to-detector distance of 5.05 m and an X-ray energy of 12 keV. The following equation was used to determine domain spacings: d=2n/q*. A Micromeritics TriStar II 3020 was used for nitrogen physisorption measurements at 77 K to determine pore textures of prepared samples, including surface areas through the Brunauer-Emmett-Teller (BET) model and pore size distributions with non-local density functional theory (NLDFT). X-ray photoelectron spectroscopy (XPS) experiments were carried out with an ESCALAB Xi+ spectrometer (Thermo Fisher) equipped with a monochromatic Al Kα X-ray source. Spectra were collected with a takeoff angle of 90° at a 3×10⁻⁷ mbar base pressure and analyzed with Avantage software from Thermo Fisher.

### Results and Discussion

To prepare 3D-structured polymers with ordered mesoporous morphologies, printed samples were exposed to sulfuric acid in the presence of dicumyl peroxide (DCP) at 135° C. In this process, the formation of radical species from DCP facilitates the selective removal of the polystyrene (PS) domains in the mixture, resulting in the formation of ordered mesopores. For the preparation of OMPs from printed SEBS:PP, degradation of PS domains occurs in the presence of acid through the generation of radical species from DCP.⁴⁹ Specifically, McCoy et al., found oxidative degradation kinetics were promoted by di-tert-butyl peroxide at elevated temperatures (100-150° C.) within a trichlorobenzene solvent. In this system, radicals derived from peroxide dissociation can rapidly abstract hydrogens from the PS backbone, leading to chain cleavage along polymer backbones. In the present method, 3D-structured OMPs are formed by directly adding 1 wt. % DCP to a reaction flask containing sulfuric acid and the printed samples. This approach is distinct from other methods, which achieved selective cleavage of PS from styrenic TPE films by first preparing TPE blends, followed by exposure to acid resulting in the formation of radical species at elevated temperature.⁵

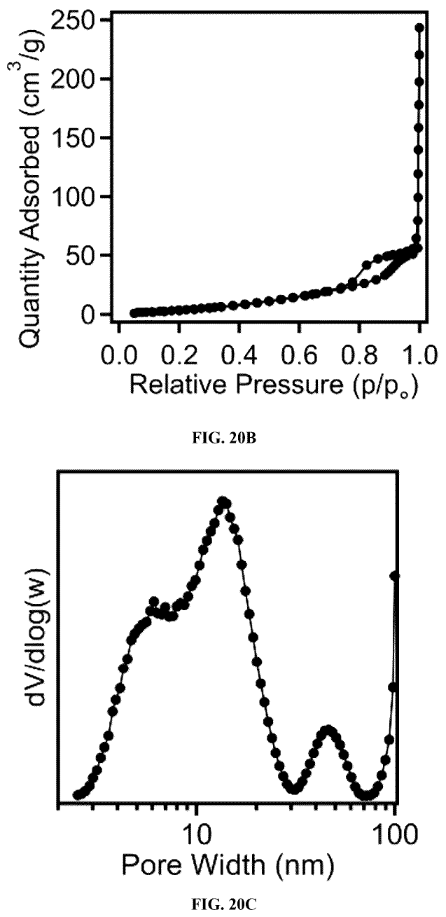

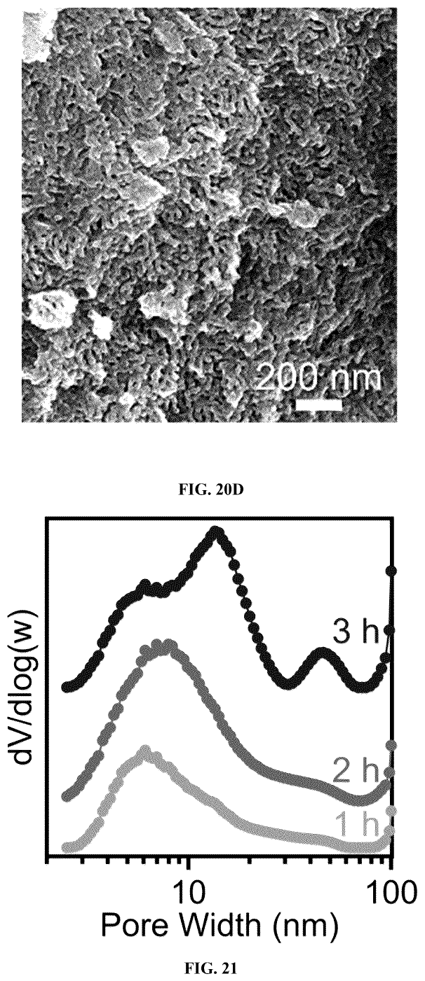

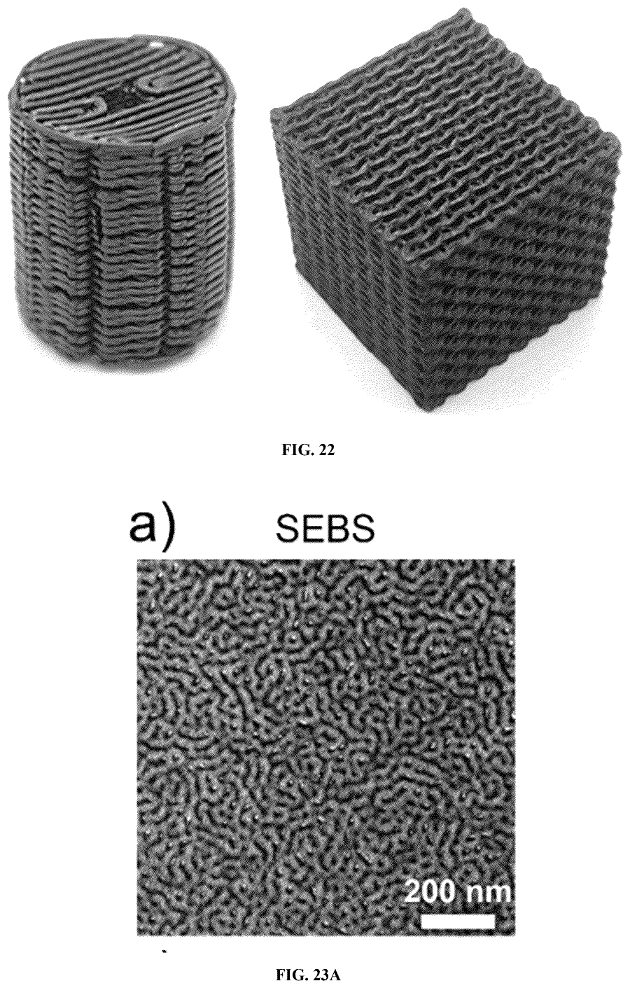

In this example, it was observed that the nanostructure of the printed SEBS:PP blend underwent a few distinct changes after sulfonation with the presence of radical species, as shown in FIG. 20A. Specifically, the domain spacing increased from 24.2 nm in the neat sample to 25.5 nm, 30.9 nm, and 33.7 nm after 1 h, 2 h, and 3 h of reaction time, respectively. The expanded domain spacing, along with slight broadening of the primary peak, were a direct result of reaction-induced swelling of both the PEB and PS domains. Nitrogen physisorption experiments of printed structures after reaction are depicted in FIG. 20B, where a typical type IV isotherm became more pronounced at longer reaction times. The surface area and pore volume were found to increase from 32.2 m²/g and 0.064 cm³/g after 1 h of reaction to 63.9 m²/g and 0.106 cm³/g after 2 h, and 252 m²/g and 0.117 cm³/g after 3 h. The corresponding pore size distributions are depicted in FIGS. 20C and 21, centered at 6.1 nm, 8.0 nm, and 13.5 nm after 1 h, 2 h, and 3 h of reaction time respectively. It is worth noting that the sample reacted for 3 h exhibited a larger secondary peak (˜48 nm) as well as a smaller shoulder (˜5.8 nm), likely due to partial degradation of the polymer matrix. FIG. 20D shows an SEM micrograph of the OMP prepared using a 3 h reaction time, illustrating the ordered mesoporous structure with pore sizes centered at 13.3 nm. The inset in FIG. 20A shows the 3D-structure of the sample reacted for 3 h, demonstrating retention of macrostructure of the model cylindrical system. To determine how the dimensions of the 3D-structure changed after conversion to OMP, several printed structures with varied initial dimensions were studied (0.5 cm, 0.75 cm, 1 cm, and 2 cm). Slight dimensional expansion (˜5%) was found in the in-plane direction due to swelling from the sulfonation reaction. However, expansion was more pronounced in the out-of-plane direction, or normal to printing deposition, where it plateaued at 67%. This significant dimensional expansion in the Z-direction may be due to the limited interlayer adhesion across layers allowing for increased swelling in contrast to the in-plane direction. FIG. 22 displays various 3D-structures after conversion to OMP, demonstrating the structural complexity achievable through this manufacturing strategy.

### Example 3

In this example, the present invention demonstrates a simple and universal strategy to prepare hierarchically mesoporous-macroporous (HMM) materials using low-cost, commodity TPE blends as precursors, including porous polymers and carbons. Specifically, incorporation of a small amount of poly(styrene)-block-poly(isoprene)-block-poly(styrene) (SIS) into a poly(styrene)-block-poly(ethylene-ran-butylene)-block-poly(styrene) (SEBS) matrix lead to macrophase separation between distinct BCPs, while retaining ordered nanostructures from self-assembly. Noteworthily, it was determined that introducing SIS additives can result in selective cleavage of polystyrene domains upon sulfonation-induced crosslinking, leading to a streamlined approach to prepare HMM polymers. Furthermore, HMM polymers can exhibit rapid sorption performance for the removal of heavy metals from water due to their large amount of negatively charged groups (sulfonic acid groups) on the pore surface.

### Materials

Poly(styrene)-block-poly(ethylene-ran-butylene)-block-poly(styrene) (SEBS; M_{w}: 118,000 g/mol, Ð: 1.59, ϕ_{PS}=20 wt. %; M_{w}: 89,000 g/mol, Ð: 1.56, ϕ_{PS}=20 wt. %; M_{w}: 100,000 g/mol, Ð: 1.67, ϕ_{PS}=18 wt. %), poly(styrene)-block-poly(isoprene)-block-poly(styrene) (SIS; M_{w}: 102,500 g/mol, Ð: 1.12, ϕ_{PS}=14 wt. %), poly(methyl methacrylate) (M_{w}: 38,000 g/mol), sulfuric acid (98%), rhodamine B (97%), nickel (II) nitrate hexahydrate (99.9%), and toluene (>99.5%) were obtained from Sigma Aldrich. Cobalt (II) chloride hexahydrate (98%-102%) and nickel (II) chloride hexahydrate (99.95%) were purchased from Thermo Scientific (Thermo Scientific, Waltham, MA). Nitric acid trace metal grade was obtained from Fisher Scientific (Fisher, Waltham, MA). Deionized (DI) water was obtained through a Millipore Sigma Milli-Q IQ 7003 ultrapure lab water purification system.

### 1.2 Synthesis of TPE Blend Derived HMM Materials

To synthesize the HMM polymers using thermoplastic elastomer (TPE) blends, parent solutions of SEBS and SIS were first prepared at 5 wt. % in toluene. After this step, 10 g of the SEBS solution and different amounts of the SIS solution (between 0.1-1 g) were blended, drop-cast onto petri dishes, and dried overnight through slow solvent evaporation. These films were then removed for subsequent processing. For performing the sulfonation-induced crosslinking reaction, 2 g of polymer blend film and 5 g of sulfuric acid were introduced, and the mixtures were heated to 145° C. for different amounts of time. Different amounts of sulfuric acid relative to polymer precursor ratios (ranging from 2.5 g to 10 g) were also investigated to determine their influence on the crosslinking reaction, where a minimal influence was observed up until a minimum amount that is required for ensuring complete submersion of the polymer in the reaction mixture. After sulfonation, crosslinked films were then washed with DI water three times to remove residual sulfuric acid and byproducts, and then completely dried at 125° C. overnight.

### General Characterization

The chemical composition of prepared samples was investigated using a Thermo Nicolet 6700 Fourier transform infrared (FTIR) spectrometer with a Smart iTR attenuated total reflection accessory and a scan range of 4000-600 cm⁻¹. The measurements were performed through averaging over 32 scans at a resolution of 4 cm⁻¹. Atomic force microscopy (AFM) analysis of TPE blends was conducted using a Dimension Icon atomic force microscope (Bruker) in Peak-Force Tapping mode. NanoScope 8.15r3sr5 software was utilized for AFM scanning, and the images were analyzed and processed using NanoScope Analysis 3.0. Peak-Force Tapping mode imaging was performed using a sharp antimony (n) doped Si cantilever (RTESPA-300, nominal tip radius of 8 nm; nominal resonance frequency of 300 kHz; nominal spring constant 40 N/m) in a standard probe holder under ambient conditions with 256×256 data point resolution. To further study the nanostructure of TPE blends and the porous materials derived therefrom, small-angle x-ray scattering (SAXS) was carried out with a Xeuss 2.0 laboratory beamline (Xenocs Inc.) with an X-ray energy of 8.05 keV and a sample-to-detector distance of 3.86 m. The domain spacing of samples, d, was determined by the equation: d=2π/q*, where q* is the scattering vector from the primary ordering peak's position within the scattering spectra. Scanning electron microscopy (SEM) was performed using a Zeiss Ultra 60 field-emission SEM to characterize the morphology of porous samples derived from the TPE blend with an accelerating voltage of 15 kV.

A Micromeritics Tristar II 3020 was used for performing nitrogen physisorption measurements at 77 K and carbon dioxide physisorption measurements at 273 K, where surface areas were determined by Brunauer-Emmett-Teller (BET) theory and non-local density functional theory (NLDFT) analysis and a carbon slit model was utilized for pore size distribution analysis. X-ray photoelectron spectroscopy (XPS) characterization was performed by an ESCALAB Xi+ spectrometer (Thermo Fisher), equipped with a MAGCIS Ar+/Am+ gas cluster ion sputter gun and a monochromatic Al X-ray source (1486.6 eV). A takeoff angle of 90° from the surface and a base pressure of 3×10⁻⁷ mbar in the analysis chamber was set for spectral acquisition. Thermo Fisher Avantage software was used for spectral analysis.

### Ion Sorption Study

To evaluate the metal ion adsorption performance of HMM polymer, metal chloride salts were dissolved in DI water and then diluted to prepare solutions with varying metal ion concentrations ranging from 5 mg/L to 5000 mg/L. For the adsorption kinetic experiment, 0.04 g of HMM polymer was added into 20 mL solutions containing 12 mg/L of metal ions in 250 mL Erlenmeyer flasks. These flasks were placed in a shaking incubator at 20° C., agitating at a speed of 300 rpm (round per minute). At designated sampling time points, 100 μL solutions were taken from the flasks. After centrifugation for 20 s, 60 μL of the supernatant was collected and mixed with DI water and 1% nitric acid to achieve a final volume of 1800 μL. Residual metal ion concentrations were determined using Agilent 5100 ICP-OES (Agilent, Santa Clara, CA). For the adsorption isotherm experiment, 1 mL solutions with varying metal ion concentrations (5 mg/L to 5000 mg/L) were combined with 0.01 g of HMM polymer in 15 mL tubes. These mixtures were subjected to the same conditions as the kinetic experiment and incubated overnight. Subsequently, the same procedure employed in the adsorption kinetic experiment was followed to prepare samples and quantify the metal ion concentrations.

For sorption measurements, the quantity adsorbed (qₜ) was determined using the following equation:

$${q}_{t} = \frac{( {C}_{o} - {C}_{e} ) * V}{M} \qquad Equation 1$$

where V is the solution's volume (L), M is the adsorbent mass (g), and Cₒ and Cₑ are the initial and equilibrium dye concentrations (mg/L), respectively. Adsorption kinetics were then fit to a pseudo-first-order adsorption model expressed as follows:

$$log ( {q}_{e} - {q}_{t} ) = log {q}_{e} - \frac{{k}_{1}}{2.303} t \qquad Equation 2$$

where qₑ (mg g⁻¹) is the amount of dye absorbed onto the sorbent at equilibrium, qₜ (mg g⁻¹) is the amount of dye absorbed onto the sorbent at time t (h), and kₗ (g mg⁻¹ h⁻¹) is the pseudo-first-order rate constant. Adsorption isotherms were fit to a Langmuir model expressed as follows:

$${q}_{e} = \frac{{q}_{m} {K}_{L} {C}_{e}}{1 + {C}_{e} {K}_{L}} \qquad Equation 3$$

where qₑ (mg g⁻¹) is the amount of dye adsorbed onto the sorbent at equilibrium, qₘ (mg g⁻¹) is the maximum adsorption capacity of the sorbent at equilibrium, Cₑ (mg L⁻¹) is the equilibrium dye concentration, and K_{L} is the Langmuir equilibrium constant which represents the affinity of sorbent binding sites.

### Results and Discussion

HMM polymers were fabricated by using TPE blends as precursors in two steps including a first mixing step, where varied contents of SIS (from 1-10 wt. %) were introduced to a SEBS matrix, and a second sulfonation-enabled crosslinking step. In this study, SEBS-SIS blends were referred to as SIS-x, where x represents the loading level (wt. %) of SIS. Briefly, SEBS-SIS blends were solution cast to establish self-assembled nanostructures through slow solvent evaporation. These TPE blend samples were then submerged in concentrated sulfuric acid at 145° C. to undergo crosslinking. For both TPEs, at elevated temperatures, sulfuric acid readily diffused and reacted with all blocks, including olefinic and polystyrene phases. Specifically, the polystyrene blocks underwent a sulfonation reaction where sulfonic acid groups were introduced to the aromatic rings preferentially at the para position.²⁶ For polyolefin segments, including poly(ethylene-ran-butylene) and polyisoprene blocks, sulfuric acid reacted with the polymeric backbone and introduced sulfonic acid groups to the polymer chain, which then underwent homolytic dissociation, producing double bonds within the backbone. Followed by a series of additional reactions, functionalized polyolefins underwent intermolecular crosslinking through a radical-radical coupling mechanism. Subsequently, SEBS-SIS blends were then washed with DI water to remove residual acid and byproducts and then dried. It was observed that inclusion of SIS resulted in cleavage of polystyrene blocks from the TPE blend matrix, forming hierarchically macro-/mesoporous crosslinked polymers. The ability to obtain HMM polymers without a calcination step is highly advantageous due to the lower energy consumption, simplified manufacturing process, and retention of functional groups in the polymer framework, which might otherwise be lost upon high temperature treatment in pyrolysis steps.

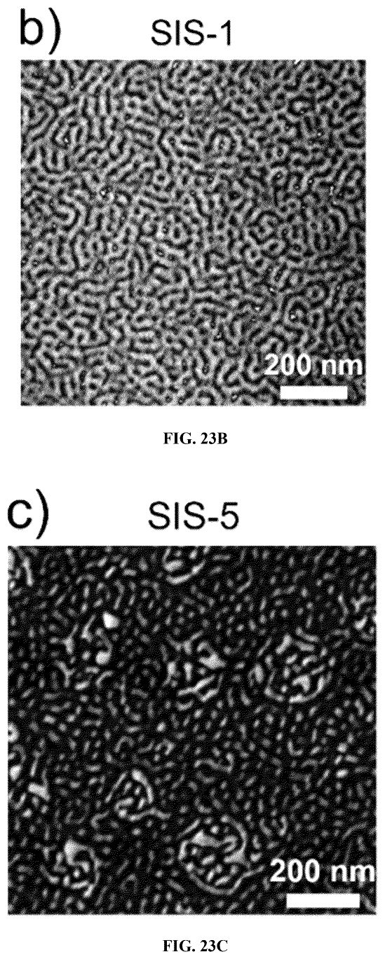

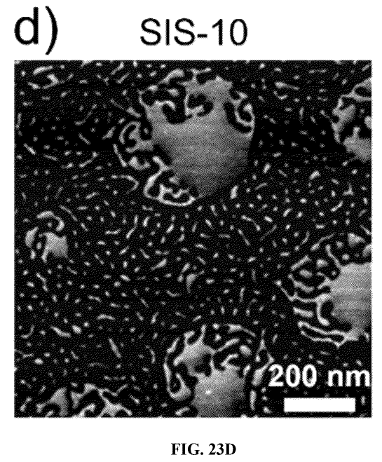

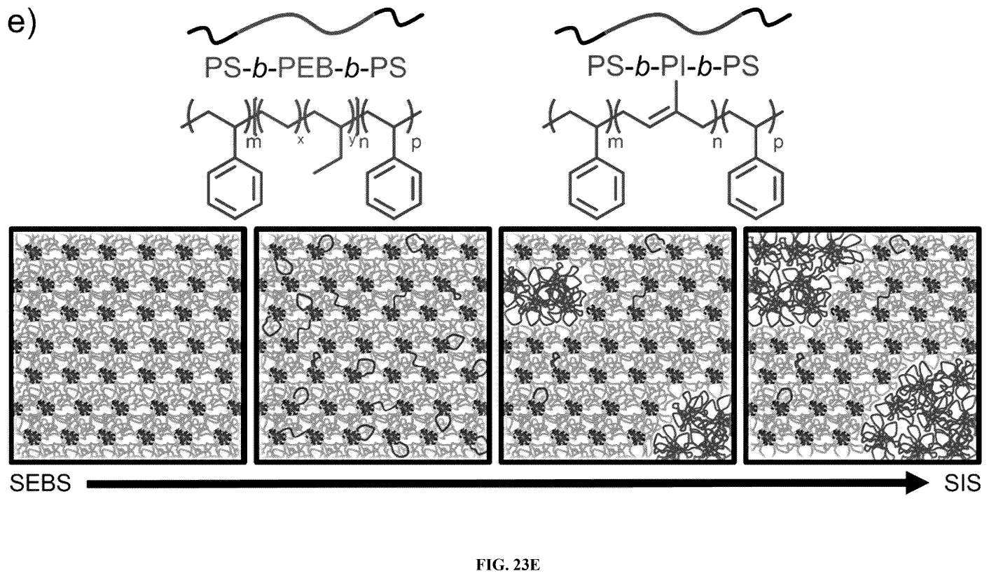

Bulk SEBS has a cylindrical morphology as shown in an AFM image (FIG. 23A), which exhibited minimal change after the addition of 1 wt. % SIS (FIG. 23B), indicating efficient mixing between these two TPEs. At greater loadings of SIS, for example, 5 wt. % and 10 wt. %, large spherical features (>100 nm) were observed (FIGS. 23C, 23D), which are associated with macrophase separation between SIS and SEBS, while nanoscale self-assembly of TPEs was also observed. The macrophase separation between SIS and SEBS^{36,37} is driven by the increased interfacial tension due to lack of favorable interaction.³⁸ As shown in FIGS. 23A-23E, increasing SIS content was observed to increase the size of macro-domains due to further enhanced polymer blend phase separation. The change in TPE-blend morphology from efficient mixing to macrophase separation with increasing SIS loading content is illustrated in FIG. 23E, and these altered polymer blend structures may impact their subsequent sulfonation-enabled crosslinking behavior.

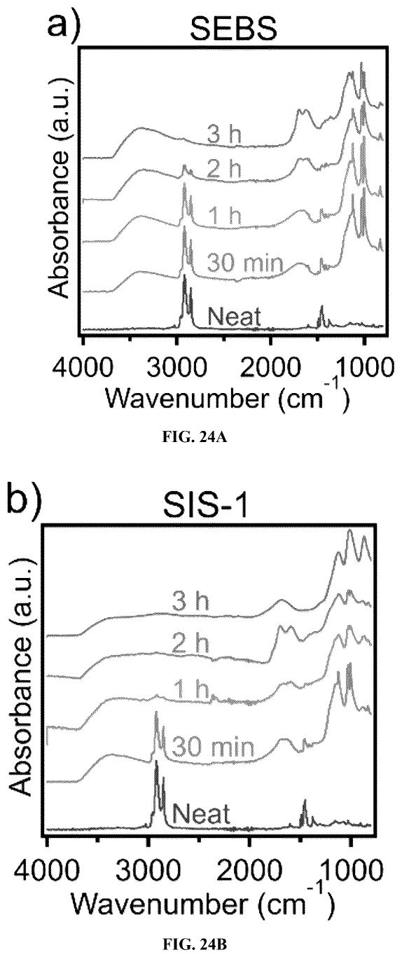

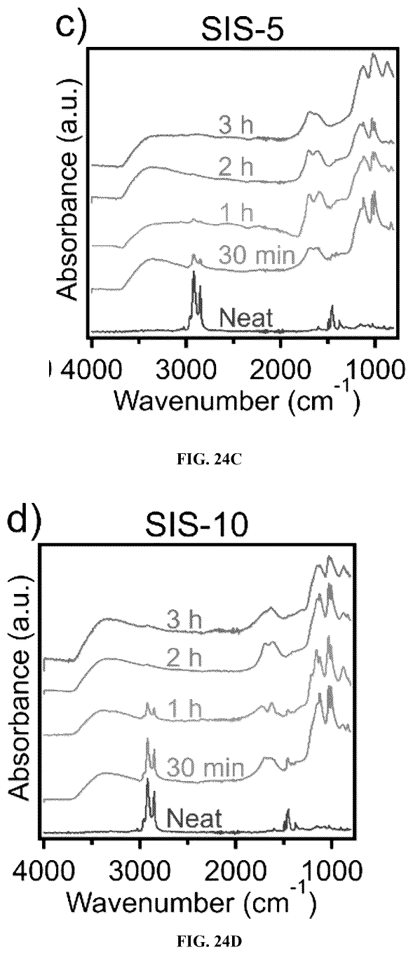

The progression of the sulfonation-induced crosslinking reaction at 145° C. was monitored through FTIR spectra to probe changes in the chemical composition of bulk SEBS and SEBS-SIS blends (FIGS. 24A-24D). Changes in several characteristic vibrations were observed, including the bands at 2910 cm⁻¹ and 2850 cm⁻¹ which correspond to alkyl stretching of the polyolefin backbone. These bands gradually decreases with increasing reaction time and become nearly absent after 3 h for the bulk SEBS, which is aligned with the existing literature.²⁶ In comparison, SIS-1 exhibited an accelerated decay in intensity with alkyl stretching. This enhanced reaction progression was slightly increased with the SIS-5 blend, where the alkyl stretch is nearly absent after 1 h reaction time. This behavior was shown to slightly lessen at even higher loadings, where SIS-10 still exhibited accelerated chemical transformation compared to bulk SEBS, though slower than for SIS-1 and SIS-5. These results suggest potentially enhanced crosslinking kinetics of SEBS-SIS blends in comparison to the bulk SEBS system. Alkyl stretching should not completely disappear even in a fully crosslinked sample, although this characteristic peak can become convoluted and hidden from the band corresponding to hydroxyl stretching. Hydroxyl stretching (˜3350 cm⁻¹) was rapidly developed within 30 min for all samples, while a band at 1600 cm⁻¹ became apparent and increased in intensity with extended reaction times, which was associated with the formation of alkenes in the olefinic backbone, further indicating the progression of crosslinking. With increasing reaction times, bands between 1700 cm⁻¹ and 1600 cm⁻¹ were also observed which suggests that side reactions occurred, leading to the possible formation of carboxylic acids, ketones, and aldehydes. However, for SEBS-SIS blends with even longer reaction times up to 3 h, these bands convoluted once again into a broad peak. Moreover, the introduction of sulfonic acid groups into the polystyrene backbone was observed with the development of a characteristic band at 1000 cm⁻¹, while their addition to the polyolefin backbone was observed at 1030 cm⁻¹. Interestingly, bulk SEBS showed these two bands retaining significant intensity at longer sulfonation times, whereas the SEBS-SIS blends at early reaction times showed a reduced intensity of the peak associated with sulfonic acid groups within the polystyrene backbone. For SEBS-SIS blends, the band at 1000 cm⁻¹ was first observed to decrease in intensity and then merge with band at 1030 cm⁻¹ at longer reaction times. This decrease and subsequent convolution of the band associated with sulfonic acid groups within the polystyrene backbone suggests a decrease in the relative amount of sulfonated polystyrene within SEBS-SIS blends in comparison to the bulk SEBS after sulfonation-based crosslinking. Overall, the chemical structure evolution indicates that the well dispersed and marginally phase separated morphologies can lead to faster reaction kinetics. This difference in reaction kinetics may be due to the presence of SIS molecules promoting the crosslinking reaction within SEBS domains. Previously, it was determined that bulk SEBS required 4 h at 150° C. to fully crosslink, confirmed by FTIR, gel fraction and mass gain, while 90 min was required for bulk SIS at 140° C.³⁹ Here, it was observed that the inclusion of SIS potentially improved the crosslinking kinetics of TPE blends.

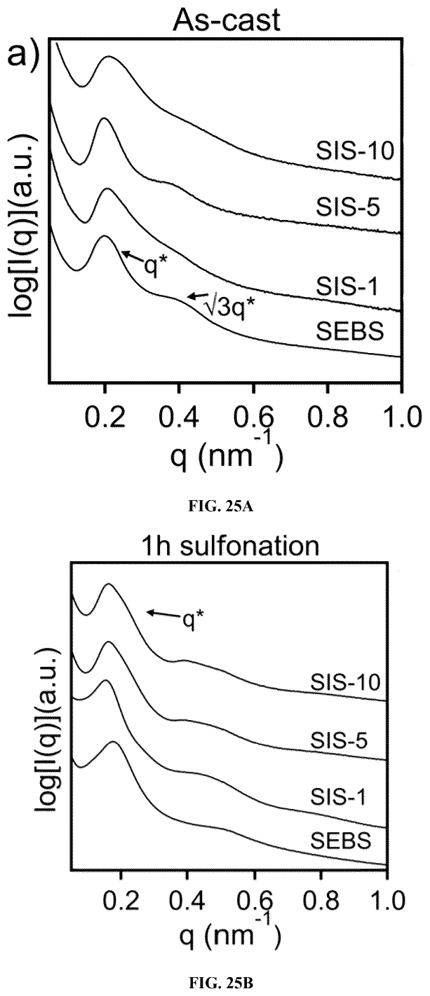

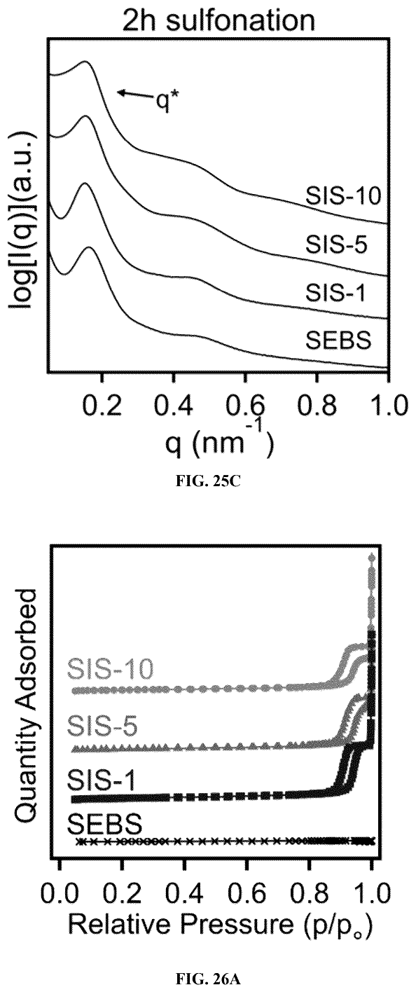

The nanostructure of SEBS-SIS precursors upon blending and sulfonation were analyzed through SAXS measurements, as shown in FIG. 25A, where the neat SEBS had a primary ordering peak (q*) of 0.20 nm⁻¹, corresponding to a domain spacing of 31.4 nm. Additional higher ordering peaks at √3q* further confirmed the presence of hexagonally packed cylindrical morphology in SEBS. For comparison, bulk SIS has a domain spacing of 28.4 nm. With 1 wt. % SIS loading, the averaged domain spacing decreased slightly to 31.1 nm followed by a further decrease to 30.3 and 29.7 nm for 5 wt. % and 10 wt. %, respectively, while a slight broadening of the primary peak was also observed. The broadening of the primary peak at higher SIS contents may be due to a slight loss in degree of ordering or convolution of the primary peak from both SEBS and SIS contributions. To assess this, the full width at half-maxima (FWHM) was determined by fitting the primary scattering peak to a Gaussian model. It was found that the bulk SEBS has a FWHM of 0.035 nm⁻¹ which then increased to 0.064 nm⁻¹ with SIS-1, indicating a slight loss in the degree of ordering after blending. The FWHM of the primary scattering peaks of SIS-5 and SIS-10 were 0.049 nm⁻¹ and 0.078 nm⁻¹, respectively, indicating their reduced nanostructural ordering compared to the bulk SEBS samples.

To determine how nanostructure is impacted by the sulfonation reaction, SAXS was carried out after 1 h and 2 h of sulfonation time (FIGS. 25B and 25C). The domain spacing of the bulk SEBS increased from 31.4 nm to 35.5 nm and 38.6 nm, after 1 h and 2 h of sulfonation time, respectively. This change was due to both the swelling of polystyrene and polyolefin domains upon reaction.⁴⁰ With 1 wt. % SIS loading, the domain spacing increased from 31.1 nm to 40.3 nm within the first hour of sulfonation-based crosslinking. After 2 h of reaction time, the domain spacing further increased to 42.2 nm; which indicated that the majority of the structural rearrangement occurred within the first hour, which is faster compared to the bulk SEBS. This behavior was also observed for the SIS-5 blend, where domain spacing increased from 30.3 nm to 39.1 nm and 41.6 nm after 1 h and 2 h of reaction time, respectively. Finally, the SIS-10 sample exhibited a similar trend with domain spacings of 39.1 and 42.2 nm after 1 h and 2 h of sulfonation, respectively. These results suggest that the presence of SIS in the SEBS matrix can play an important role in controlling their morphological evolution. It is known that sulfonation-induced crosslinking of SIS leads to macropore formation and a complete loss of ordered structures,³⁹ due to the highly reactive isoprene unit resulting in significant gaseous byproducts released from polymer frameworks. From the SAXS results in FIGS. 25A-25C, it was observed that mesostructural ordering of all samples were retained. The slight increase in domain spacing for the SEBS-SIS blends, compared to their SEBS-only counterpart, can be attributed to the portion of SIS that is efficiently mixed slightly expanding the nanostructure.

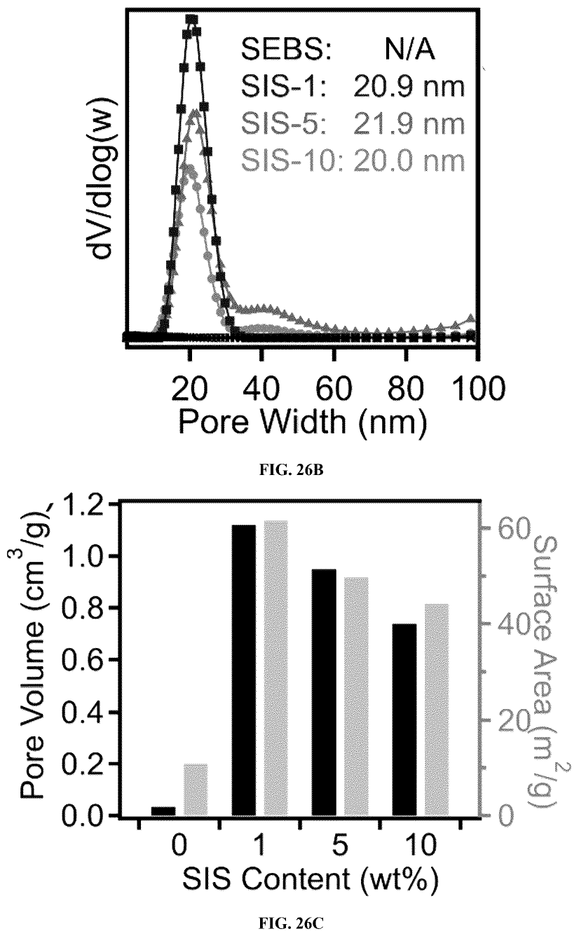

After sulfonation-induced crosslinking for 2 h, crosslinked TPE blends were characterized using liquid nitrogen physisorption measurements, which are shown in FIG. 26A. The bulk SEBS, as anticipated, has no presence of mesopores or macropores, however, it is very interesting that a type IV isotherm, indicative of ordered mesoporous materials, was observed for all SEBS-SIS blends. This suggests the inclusion of SIS results in the removal of styrene blocks within the SEBS majority, leading to the formation of mesopores in the polymer framework. The pore size distributions of these samples are shown in FIG. 26B, which were derived from the NLDFT model. It was determined that the bulk SEBS had no mesopores, whereas the crosslinked SEBS-SIS blends had pore size distributions centered at 20.9, 21.9, and 20.0 nm for SIS-1, SIS-5, and SIS-10, respectively. Moreover, FIG. 26C shows the resulting pore volume and BET surface areas of different samples, where the bulk SEBS had a very low pore volume of 0.04 cm³/g, which increased to 1.12, 0.95, and 0.73 cm³/g for SIS-1, SIS-5, and SIS-10, respectively. The sulfonated SEBS also exhibited a low surface area of 11 m²/g, which increased to 62, 50, and 44 m²/g for SIS-1, SIS-5, and SIS-10, respectively. For HMM polymers derived from SEBS-SIS blends, the decreasing pore volume and surface area with increasing SIS loading level could be attributed to a relative decrease in SEBS content in the blend systems.

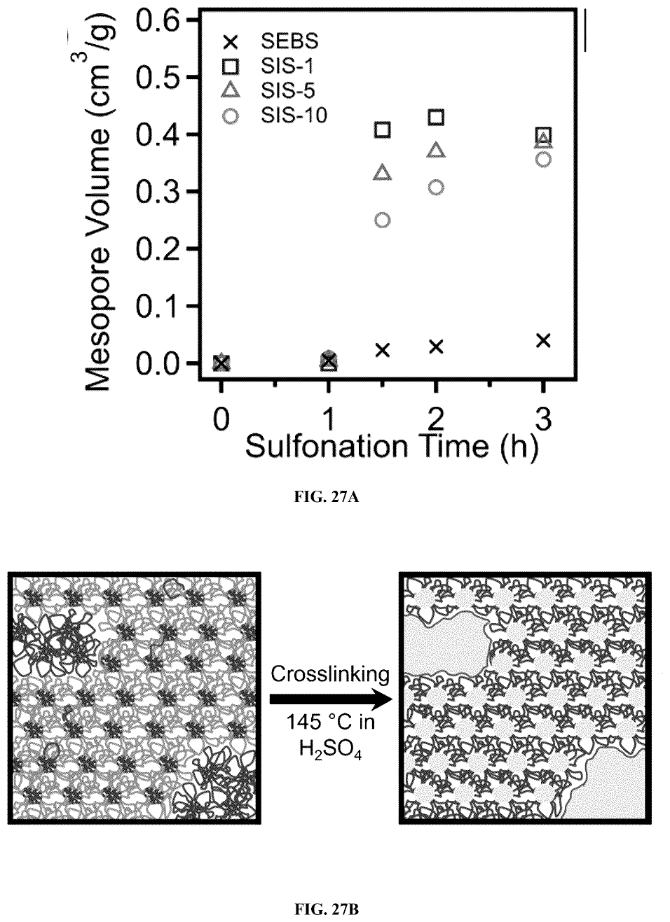

To understand how incorporation of SIS leads to mesopore formation, nitrogen physisorption experiments were carried out for bulk SEBS and SEBS-SIS blends at various sulfonation reaction times. FIG. 27A displays mesopore volume as a function of sulfonation time, where the bulk SEBS has minimal pore volume for the first few hours, though a slight increase to ˜0.04 cm³/g was observed after 3 h of reaction time. The SEBS-SIS blends had no mesopore volume within the first hour of sulfonation, though beginning at 1.5 h, mesopore volume increased to 0.41, 0.33, and 0.25 cm³/g for SIS-1, SIS-5, and SIS-10, respectively. After 3 h of reaction time, mesopore volume appeared to plateau with values of 0.40, 0.39, and 0.36 cm³/g for SIS-1, SIS-5, and SIS-10, respectively. The ability to selectively decompose polystyrene domains in TPEs through a sulfonation step is intriguing, as this phenomenon is observed for the first time. The removal of polystyrene is primarily attributed to the incorporation of SIS, while the underlying mechanism is complicated. Here, the incorporation of highly reactive polyisoprene units coupled with sulfuric acid and elevated temperatures (145° C.) may generate radical species in the system. As a result, these radicals after 1.5 h of reaction time selectively degrade polystyrene blocks during the crosslinking of the olefinic phases in the presence of strong acid, resulting in the formation of a crosslinked macro-/mesoporous polymer. A schematic illustration showing the conversion of SEBS-SIS blends to HMM polymers is provided in FIG. 27B. These results confirm that introducing a small amount of homopolymer that undergoes degradation to form additional radical species during the sulfonation reaction leads to the fabrication of a HMM polymer, enabling the cleavage of polystyrene groups from the polymer backbone and the formation of mesopores.

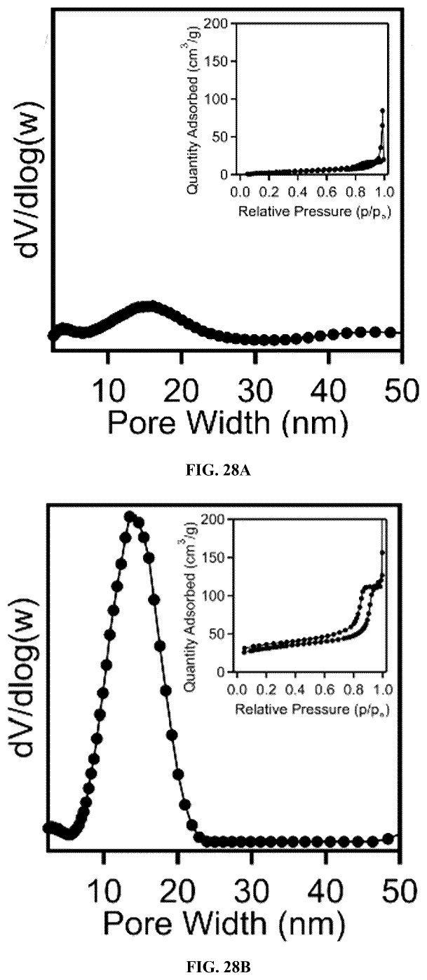

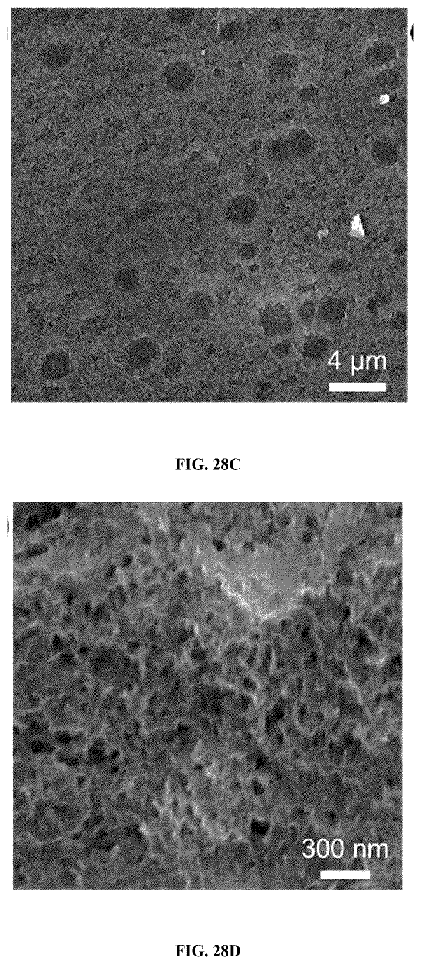

Another experiment was carried out where a blend of SEBS with a small amount of homopolymer was prepared, specifically 5 wt. % poly(methyl methacrylate) (PMMA; M_{w}: 38,000 g/mol). After sulfonation-based crosslinking at 145° C. for 1 h, no pore formation was observed through nitrogen physisorption characterization (FIG. 28A). However, after 2 h, a type IV isotherm was once again observed through nitrogen physisorption with a pore size centered at 13.5 nm and a mesopore volume of 0.15 cm³/g (FIG. 28B). Macropores and mesopores were visually observed through SEM imaging (FIGS. 28C and 28D), though compared to SEBS-SIS blends, less macropores were observed within the carbon framework in addition to a reduced ordering in mesopores. The formation of macro-/mesoporous polymer can be directly attributed to the presence of 5 wt. % homopolymer, where PMMA undergoes acid hydrolysis during the crosslinking reaction which forms radical species that facilitate the formation of porous polymer. However, the reduction in macro- and mesopore uniformity is due to strong phase separation in the SEBS-PMMA system. In the SEBS-SIS system, macropores can be derived from the formation of gaseous byproducts that result in more uniform macropore formation. Furthermore, the reduced mesopore volume in the SEBS-PMMA polymer indicates that the SEBS-SIS system is more efficient for producing macro-/mesoporous crosslinked polymer.

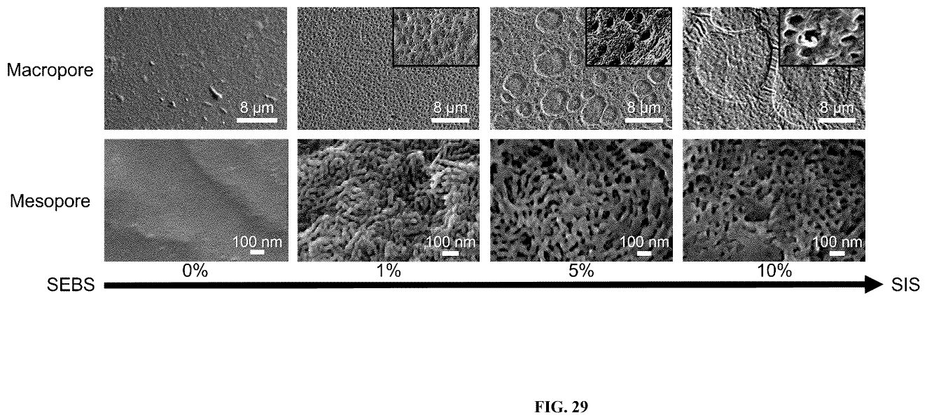

The hierarchical macro-/mesoporous morphology of the crosslinked polymer was further investigated through SEM imaging in FIG. 29, where the bulk SEBS sample does not exhibit either macropores or mesopores upon sulfonation for 2 h. For the SIS-1 blend, macropores were observed throughout the structure. This could be a result of the efficient mixing of SIS in the composition which resulted in gaseous byproduct formation and the corresponding release of gas created macropores in the polymer framework. With the SIS-5 and SIS-10 samples, craters were observed on the surface. These craters were of several microns in size with a diameter of ˜4.6 μm for SIS-5 and ˜14.5 μm for SIS-10 and were attributed to SIS macrophase separation. Insets are provided to better observe reaction-induced macropores, where SIS-1 has a range of pore sizes between 220 nm and 460 nm, SIS-5 has a range of pore sizes between 690 nm and 900 nm, and SIS-10 has a range of pore sizes between 1.2 nm and 2.0 μm. The pore formation is attributed to the sulfonation reaction, which released gaseous products. These macropore sizes at higher SIS loadings began to approach values previously reported for bulk SIS after sulfonation (4.3-6.0 μm). From FIG. 29, an ordered mesoporous morphology with averaged pores size centered at 20.6 nm, 21.7 nm, and 19.6 nm was observed through SEM for SIS-1, SIS-5, and SIS-10, respectively. These SEM imaging results confirm the formation of both macropores and mesopores in these SEBS-SIS blend materials, through a simple and scalable sulfonation reaction process.

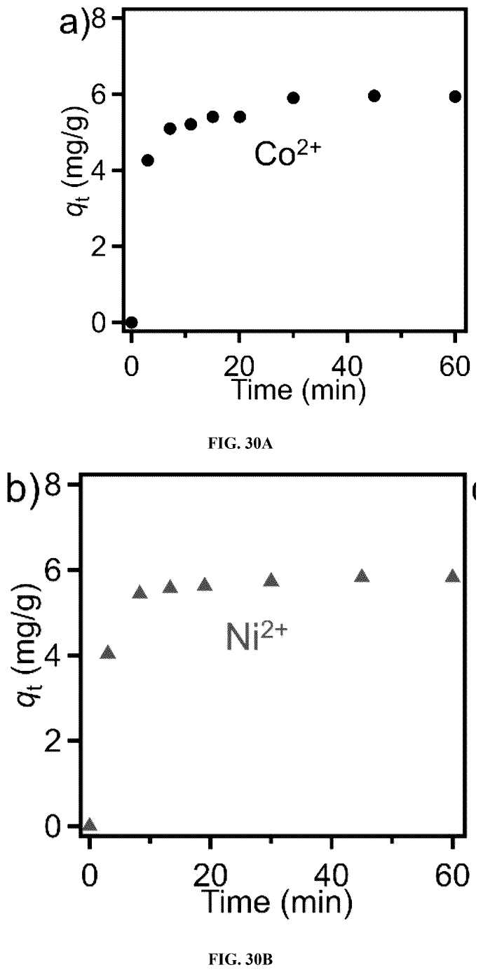

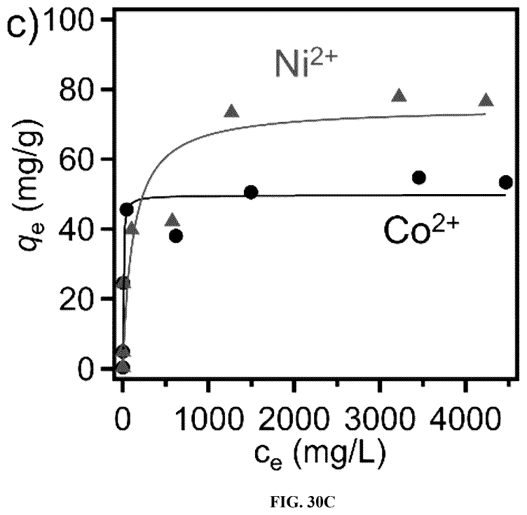

An important application of HMM polymers is their use as sorbents for water remediation, where the removal of toxic heavy metal ions from aqueous environments has been demonstrated with various polymeric systems. To demonstrate the practical application of TPE blend-derived HMM polymers, adsorption studies were carried out with two model compounds, including Co²⁺ and Ni²⁺. Specifically, the SIS-5 HMM polymer was selected for investigating adsorption kinetics for these two metal ions by monitoring the change in metal ion concentration over contact time, starting with an initial metal ion concentration of 12 mg/L. FIGS. 30A and 30B show that SIS-5 HMM polymer achieved adsorption equilibrium for Co²⁺ and Ni²⁺ within only 20 minutes, accompanied by significantly high removal rates for Co²⁺ and Ni²⁺ (95.3% and 92.9%, respectively), which surpass efficiencies reported in many previous studies. The adsorbed concentrations of Co²⁺ and Ni²⁺ reached 5.96 mg/g and 5.87 mg/g, respectively, despite their low initial concentrations, suggesting rapid kinetics and a strong affinity of the HMM polymer for heavy metal ions. The adsorption isotherms of the HMM polymer for both Co²⁺ and Ni²⁺ fit well with the Langmuir model as observed in FIG. 30C, where Co²⁺ exhibited a maximum adsorption capacity (qₘ) of 49.7 mg/g and a Langmuir equilibrium constant (K_{L}) of 0.192 L/mg, while Ni²⁺ showed a qₘ of 74.9 mg/g and a K_{L} of 8.42×10⁻³ L/mg (Table S2). Specifically, in terms of Co²⁺ adsorption, the HMM polymer exhibited both qₘ and K_{L} values that rank among the highest compared to those reported in other studies. For instance, the qₘ of the polymer according the present invention was approximately 14 times higher than that of an anthranilic acid-2-aminopyridine-formaldehyde terpolymer,⁶⁴ and the K_{L} was about 7 times higher than that of a mesoporous silica-supported polyethyleneimine.⁶⁰ Notably, the adsorption of Co²⁺ on the HMM polymer reached equilibrium in just 20 minutes, suggesting fast kinetics of Co²⁺ adsorption on the HMM polymer, which is crucial for applications in flow-through columns designed for removing metals from water. Regarding Ni²⁺ adsorption, despite exhibiting a relatively small K_{L} value, the HMM polymer still reached equilibrium in less than 20 minutes. Collectively, these experiments provide fundamental insights into the properties of the HMM polymer of the present invention for metal ion adsorption, while highlighting their potential for metal removal applications. Furthermore, the present method for preparing HMM polymers employed herein utilizes cost-effective commodity plastics as the starting materials, in conjunction with a simple sulfonation step, which can provide high scalability to address practical applications.

The present invention provides methods to convert commodity thermoplastic elastomer blends to HMM materials, enabled by sulfonation-induced crosslinking. The incorporation of isoprene units was found to facilitate the selective cleavage of polystyrene domains with the presence of acid, leading to the fabrication of HMM polymers with a uniform pore size distribution of mesopores. Moreover, low amounts of SIS content can accelerate crosslinking kinetics. Furthermore, it was demonstrated that the HMM materials derived from the TPE blends can be employed as high-performance sorbents for the efficient removal of heavy metal ions from aqueous systems. The present invention, therefore, provides a streamlined and innovative method for the preparation of useful porous materials containing distinct pore sizes and tailorable morphologies.

What is claimed is:

1. A porous ionic polymer formed via a one-step reaction comprising a step of:
crosslinking one or more thermoplastic elastomers in a presence of one or more acids comprising sulfur, and one or more free radical generators to form the porous ionic polymer.

2. The porous ionic polymer of claim 1, wherein the one or more thermoplastic elastomers is a poly(styrene)-block-poly(ethylene-ran-butylene)-block-poly(styrene) copolymer.

3. The porous ionic polymer of claim 2, wherein the poly(styrene)-block-poly(ethylene-ran-butylene)-block-poly(styrene) copolymer is a component from post-industrial waste.

4. The porous ionic polymer of claim 1, wherein the one or more acids is selected from the group consisting of sulfuric acid, sulfurous acid, thiosulfuric acid, peroxydisulfuric acid, polythionic acids, thiosulfurous acid, peroxymonosulfuric acid, dithionous acid, tetrathionic acid, and dithionic acid.

5. The porous ionic polymer of claim 1, wherein the porous ionic polymer comprises block copolymers, wherein each block comprises repeat units and 1-20% of the repeat units are functionalized with sulfonic acid groups.

6. The porous ionic polymer of claim 1, wherein the one or more mesoporous polymers has a pore volume of from about 0.1 cm³/g to about 0.5 cm³/g, as measured by nitrogen physisorption with Barrett-Joyner-Halenda analysis.

7. The porous ionic polymer of claim 1, wherein the porous ionic polymer has a surface area of from about 100 m²/g to about 300 m²/g.

8. A water remediation device comprising the porous ionic polymer of claim 1.

9. The water remediation device of claim 8, having an adsorption capacity for methylene blue of from about 50 mg/g to about 1000 mg/g of the porous ionic polymer.

10. A method of forming a porous ionic polymer via a one-step reaction comprising a step of:
crosslinking one or more thermoplastic elastomers in the presence of one or more acids comprising sulfur, and one or more free radical generators at a temperature of from about 100° C. to about 200° C. to form the porous ionic polymer.

11. The method of claim 10, wherein the crosslinking step is carried out for a duration of from about 45 minutes to about 300 minutes.

12. The method of claim 10, wherein the one or more free radical generators is selected from the group consisting of dicumyl peroxide, benzoyl peroxide, azoisobutyronitrile, 2,2′-azobis(2-methylpropionitrile), potassium persulfate, lauroyl peroxide, cumene hydroperoxide, tert-butyl hydroperoxide, azobisisobutyronitrile, di-tert-butyl peroxide, methyl ethyl ketone peroxide, cumyl hydroperoxide, peroxyacetic acid, and hydrogen peroxide.

13. The method of claim 10, wherein the one or more free radical generators is present in an amount of from about 0.001 wt. % to about 10 wt. %, based on a total weight of the combination of the one or more thermoplastic elastomers, the one or more acids comprising sulfur, and the one or more free radical generators.

14. The method of claim 10, wherein the one or more thermoplastic elastomers comprise a triblock polymer, wherein a first block, a second block, and a third block may each be independently selected from the group consisting of poly(styrene), poly(ethylene), poly(butylene), and combinations thereof.

15. The method of claim 14, wherein the poly(styrene)-block-poly(ethylene-ran-butylene)-block-poly(styrene) copolymer is in powder form, bead form, or 3D-printed.

16. The method of claim 10, wherein the one or more thermoplastic elastomers is a poly(styrene)-block-poly(ethylene-ran-butylene)-block-poly(styrene) copolymer.

17. The method of claim 10, wherein the one or more acids is selected from the group consisting of sulfuric acid, sulfurous acid, thiosulfuric acid, peroxydisulfuric acid, polythionic acids, thiosulfurous acid, peroxymonosulfuric acid, dithionous acid, tetrathionic acid, and dithionic acid.

18. The method of claim 10, wherein the one step reaction is configured to provide a porous ionic polymer comprising block copolymers, wherein each block comprises repeat units and 1-20% of the repeat units are functionalized with sulfonic acid groups.

19. The method of claim 10, wherein self-assembled nanostructures selected from the group consisting of spheres, cylinders, and gyroids are formed in the crosslinking step.

20. The method of claim 10, wherein the method excludes a calcination step after the crosslinking step.
